(19) United States
(12) Patent Application Publication
(10) Pub. No.: US 2021/0045215 A1
(43) Pub. Date: Feb. 11, 2021

(54) LIGHT CONTROL SYSTEM AND LIGHT CONTROL DEVICE

(71) Applicants: SHARP KABUSHIKI KAISHA, Sakai City, Osaka (JP); NARA WOMEN'S UNIVERSITY, Nara-shi, Nara (JP)

(72) Inventors: MASAHIRO TSUJIMOTO, Sakai City, Osaka (JP); SHUN UEKI, Sakai City, Osaka (JP); TSUYOSHI KAMADA, Sakai City, Osaka (JP); YUSUKE TSUDA, Sakai City, Osaka (JP); YOUKO INOUE, Nara-shi, Nara (JP)

(21) Appl. No.: 16/979,509

(22) PCT Filed: Mar. 6, 2019
(86) PCT No.: PCT/JP2019/008852

§ 371 Date: Sep. 9, 2020

(30) Foreign Application Priority Data
Mar. 9, 2018 (JP) 2018-043579

(51) Int. Cl. H05B 47/11

(52) U.S. Cl. CPC H05B 47/11

(57) ABSTRACT

A light control system includes a daylighting unit that takes in outside light, a lighting unit that is able to adjust an output of light, an acquisition unit that acquires brightness information representing brightness, including at least brightness of the outside light taken in from the daylighting unit, and a control unit that controls the output of light toward a target value. The control unit changes the target value based on the brightness information.

### TECHNICAL FIELD

The present invention relates to a light control system and a light control device.

The present application claims priority to Japanese Patent Application No. 2018-043579 filed in Japan on Mar. 9, 2018, and the content thereof is incorporated herein.

### BACKGROUND ART

In the related art, there is a known lighting control system that measures an illuminance of a lighting area with an illuminance sensor and controls a lighting device based on the measurement result.

PTL 1 describes a lighting control system used in a building such as an office building or a house. Such a lighting control system is used in a room where a lighting device is provided and outside light such as sunlight enters from a window, and an illuminance information signal is transmitted to a lighting control device based on an illuminance in a lighting area. In a case where the illuminance in the lighting area falls below a threshold value due to the influence of outside light or the like, the illuminance information signal representing an illuminance exceeding a standard is transmitted to the lighting control device. The lighting control system has been proposed in which the lighting control device controls the lighting device based on the illuminance information signal exceeding the standard without waiting for reception of a next illuminance information signal by periodic transmission to quickly return the illuminance in the lighting area to be within an allowable range of a certain target value.

### CITATION LIST

### Patent Literature

PTL 1: Japanese Unexamined Patent Application Publication No. 2013-127930

### SUMMARY OF INVENTION

### Technical Problem

However, in PTL 1, in a case where the illuminance in the lighting area deviates from the allowable range by a certain amount due to a fluctuation in the illuminance of the outside light and then there is a change such that the illuminance of the outside light becomes constant, a large change in the illuminance occurs twice due to the fluctuation in the illuminance of the outside light and follow-up control thereof for each fluctuation in the illuminance of the outside light since a target value of the illuminance is constant. Therefore, there is a problem that the comfort of a person in the room is highly likely to be damaged.

One aspect of the present invention has been made in view of the above points and provides a light control system and a light control device that control an illuminance while suppressing an amount of change in illuminance.

### Solution to Problem

(1) The present invention has been made to solve the above problems, and an aspect of the present invention is a light control system including a daylighting unit that takes in outside light, a lighting unit that is able to adjust an output of light, an acquisition unit that acquires brightness information representing brightness, including at least brightness of light taken in from the daylighting unit, and a control unit that controls the output of light toward a target value. The control unit changes the target value based on the brightness information.

(2) Another aspect of the present invention is the light control system according to (1), in which the control unit changes the target value based on brightness information representing the brightness of the outside light.

(3) Another aspect of the present invention is the light control system according to (1) or (2), in which an interval for changing the target value is longer than a time for continuing the control of the output of light in the control unit.

(4) Another aspect of the present invention is the light control system according to any one of (1) to (3), in which the control unit changes the target value to a high value in a case where the brightness indicated by the brightness information is higher than predetermined brightness.

(5) Another aspect of the present invention is the light control system according to any one of (1) to (4), in which the control unit changes the target value to a low value in a case where the brightness indicated by the brightness information is lower than predetermined brightness.

(6) Another aspect of the present invention is the light control system according to any one of (1) to (5), in which the control unit changes the target value to a high value in a case where the brightness indicated by the brightness information is predicted to be lower than predetermined brightness.

(7) Another aspect of the present invention is the light control system according to any one of (1) to (6), in which the control unit changes the target value to a low value in a case where the brightness indicated by the brightness information is predicted to be higher than predetermined brightness.

(8) Another aspect of the present invention is the light control system according to any one of (1) to (7), in which the control unit changes the target value to 500 lx or more as a low value of the target value, and changes the target value to 1,000 lx or less as a high value of the target value.

(9) Another aspect of the present invention is the light control system according to any one of (1) to (8), in which the acquisition unit is a sensor that measures brightness of outdoor light and the lighting unit is lighting disposed indoors.

(10) Another aspect of the present invention is the light control system according to one of (1) to (9), in which the acquisition unit is an illuminance sensor installed on a window surface or a solar irradiance meter installed on a roof.

(11) Another aspect of the present invention is the light control system according to any one of (1) to (10), in which the acquisition unit includes a first acquisition unit which is a sensor installed on a window surface or a solar irradiance meter installed on a roof and a second acquisition unit which is a sensor that measures brightness of a desk top surface, a floor surface, or a wall surface, and the control unit changes the target value relating to second brightness information acquired by the second acquisition unit, based on first brightness information acquired by the first acquisition unit.

(12) Another aspect of the present invention is the light control system according to any one of (1) to (11), in which the acquisition unit is an illuminance sensor that measures brightness of a desk top surface, a floor surface, or a wall surface, and the control unit changes the target value based on brightness information representing the brightness of the desk top surface, the floor surface, or the wall surface.

(13) Another aspect of the present invention is the light control system according to any one of (1) to (12), in which the acquisition unit acquires information representing a sky image or a cloud amount, and the control unit changes the target value according to whether or not the sun is hidden by a cloud.

(14) Another aspect of the present invention is the light control system according to any one of (1) to (13), in which the lighting unit is any one of lighting that illuminates a visual work surface or lighting that illuminates surroundings.

(15) Another aspect of the present invention is the light control system according to (14), in which the lighting unit is the lighting that illuminates surroundings, the target value is changed to 100 lx or more as a low value of the target value, and the target value is changed to 500 lx or less as a high value of the target value.

(16) Another aspect of the present invention is a light control device including a daylighting unit that takes in outside light, a lighting unit that is able to adjust an output of light, an acquisition unit that acquires brightness information representing brightness, including at least brightness of the outside light taken in from the daylighting unit, a control unit that controls a light output of a lighting device toward a target value, and an acquisition unit that acquires brightness information representing brightness. The control unit changes the target value based on the brightness information.

### Advantageous Effects of Invention

According to one aspect of the present invention, it is possible to control the illuminance while the comfort of the person in the room is ensured.

### BRIEF DESCRIPTION OF DRAWINGS

FIG. 1 is a one-point perspective view showing an application example of a light control system according to a first embodiment of the present invention.

FIG. 2 is a configuration diagram of the light control system according to the present embodiment.

FIG. 3 is a flowchart 1 related to light control of the light control system according to the present embodiment.

FIG. 4 is a flowchart 2 related to the light control of the light control system according to the present embodiment.

FIG. 5 is an example of a temporal change in a measurement result when a first illuminance sensor L1 continuously measures brightness in the present embodiment.

FIG. 6 is a diagram showing a temporal change in brightness and the like when the brightness is controlled in the light control system according to the present embodiment.

FIG. 7 is a diagram showing a temporal change in brightness and the like when the brightness is controlled in the light control system according to the present embodiment.

FIG. 8 is a diagram showing a relationship between a discomfort rate of a visual worker and a rate of change in brightness when the brightness is controlled in the light control system according to the present embodiment.

FIG. 9 is a flowchart 2′ related to the light control of the light control system in a modification example of the first embodiment of the present invention.

FIG. 10 is a diagram showing a temporal change in brightness and the like when the brightness of the light control system is controlled in the modification example of the first embodiment of the present invention.

FIG. 11 is a flowchart 1 related to light control of a light control system according to a second embodiment of the present invention.

FIG. 12 is a diagram showing a temporal change in brightness and the like when the brightness is controlled in the light control system according to the present embodiment.

FIG. 13 is a diagram showing a temporal change in brightness and the like when the brightness is controlled in the light control system according to the present embodiment.

FIG. 14 is an example of a temporal change in a measurement result when a solar irradiance meter continuously measures a solar irradiance in a third embodiment of the present invention.

FIG. 15 is a flowchart 1 related to light control of a light control system according to the present embodiment.

FIG. 16 is a flowchart 2 related to the light control of the light control system according to the present embodiment.

FIG. 17 is a diagram showing a temporal change in brightness and the like when the brightness is controlled in the light control system according to the present embodiment.

FIG. 18 is a diagram showing an example of a temporal change in measured values of brightness by a first illuminance sensor and a second illuminance sensor in a fourth embodiment of the present invention.

FIG. 19 is a flowchart 1 related to light control of a light control system according to the present embodiment.

FIG. 20 is a diagram showing an example of a sky image captured by a camera in a fifth embodiment of the present invention.

FIG. 21 is a flowchart 1 related to light control of a light control system according to the present embodiment.

FIG. 22 is a flowchart 2 related to the light control of the light control system according to the present embodiment.

FIG. 23 is a diagram showing a temporal change in brightness and the like when the brightness is controlled in the light control system according to the present embodiment.

FIG. 24 is a one-point perspective view showing an application example of a light control system according to a sixth embodiment of the present invention.

FIG. 25 is a flowchart 2 related to light control of a light control system according to the present embodiment.

### DESCRIPTION OF EMBODIMENTS

### First Embodiment

Hereinafter, embodiments of the present invention will be described with reference to the drawings.

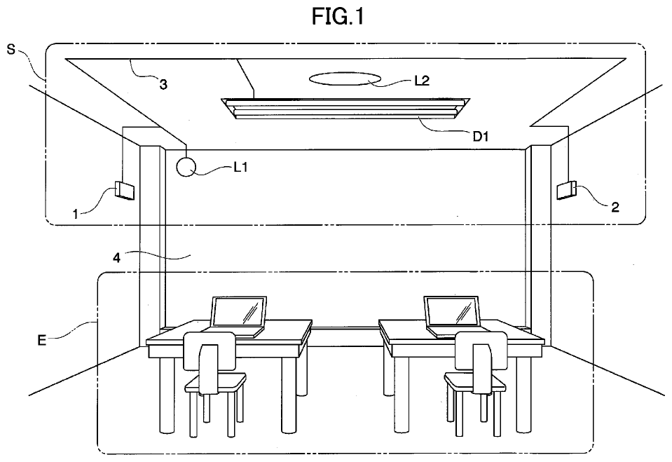

FIG. 1 shows an application example of a light control system S according to a first embodiment of the present invention. The light control system S is, for example, a lighting control system or a lighting control device. The light control system S is configured in a room and includes a lighting control unit 1, a first illuminance sensor L1, a second illuminance sensor L2, a first lighting device D1, a setting device 2, a signal line 3, and a daylighting device 4.

There is a work environment E in addition to the light control system S in the room, and a person in the room performs desk work or some work using vision.

The lighting control unit 1 is installed on a wall surface in the room, acquires information on brightness measured by any one or both of the first illuminance sensor L1 and the second illuminance sensor L2, and acquires setting information related to light control acquired from the setting device 2.

The setting information related to the light control includes information representing whether a function of changing a target illuminance is valid or invalid (light output control function on/off information).

The setting information relating to the light control includes detailed information relating to light output control (light output control information). The light output control information is, for example, a target illuminance, an allowable fluctuation range of a target value, or the like, and details of the light output control information will be described below.

The lighting control unit 1 changes the target illuminance based on the acquired information to control a light output emitted from the first lighting device D1.

The lighting control unit 1 is installed on the wall surface, but the installation place is not limited thereto. The lighting control unit 1 may be installed, for example, on the ceiling.

The first illuminance sensor L1 and the second illuminance sensor L2 include respectively a sensor element based on a photoelectric conversion element or the like inside, measure the brightness in the environment in which each sensor is installed, and transmit information on the measured brightness to the lighting control unit 1. In the present embodiment, the first illuminance sensor L1 and the second illuminance sensor L2 are respectively installed near the daylighting device 4 and the ceiling in the room. However, the installation place is not limited to the above and may be a wall surface, the work environment E, or the like.

The first lighting device D1 is installed on the ceiling and illuminates the installed environment with light. The first lighting device D1 receives a control signal relating to the light output from the lighting control unit 1 and changes the intensity of the emitted light based on the signal.

The first lighting device D1 is, for example, a fluorescent lamp or a light emitting diode (LED) lighting. The installation place of the first lighting device D1 is not limited to the ceiling and may be, for example, a wall surface.

The setting device 2 is installed on a wall surface and acquires the light output control function on/off information and the light output control information input from the outside. The setting device 2 outputs the light output control function on/off information and the light output control information to the lighting control unit 1. The installation place of the setting device 2 is not limited to the wall surface, and the setting device 2 may be installed in the work environment E.

The signal line 3 connects the lighting control unit 1, the first illuminance sensor L1, the second illuminance sensor L2, the first lighting device D1, and the setting device 2 in the light control system S by a wired communication medium. Although the lighting control unit 1, the first illuminance sensor L1, the second illuminance sensor L2, the first lighting device D1, and the setting device 2 are connected in a bus type by the signal line 3, the present embodiment is not limited thereto. For example, the setting device 2, the first illuminance sensor L1, the second illuminance sensor L2, the first lighting device D1, and the setting device 2 may be connected to the lighting control unit 1 in a one-to-one relationship.

The information is transmitted and received between the lighting control unit 1, the first illuminance sensor L1, the second illuminance sensor L2, the first lighting device D1, and the setting device 2 through the signal line 3.

A communication interface such as Ethernet (registered trademark) may be used for transmitting and receiving the information through the signal line 3.

Alternatively, a wireless communication interface such as Wi-Fi (registered trademark), ZigBee (registered trademark), or a mobile phone network may be used, instead of the signal line 3, for transmitting and receiving the information between the lighting control unit 1, the first illuminance sensor L1, the second illuminance sensor L2, the first lighting device D1, and the setting device 2.

The daylighting device 4 is installed on a side surface of the room and brings the brightness of the outside into the room. In the present embodiment, a window will be described as an example of the daylighting device 4, but the present invention is not limited thereto. The daylighting device 4 may be a daylighting film, a light shelf, a light duct, a blind, or the like. The installation place of the daylighting device 4 is not limited to the wall surface and may be the ceiling or the floor.

The work environment E includes, for example, a desk, a chair, a personal computer, and the like, and is an environment for performing work using vision (visual work) in the light control system S.

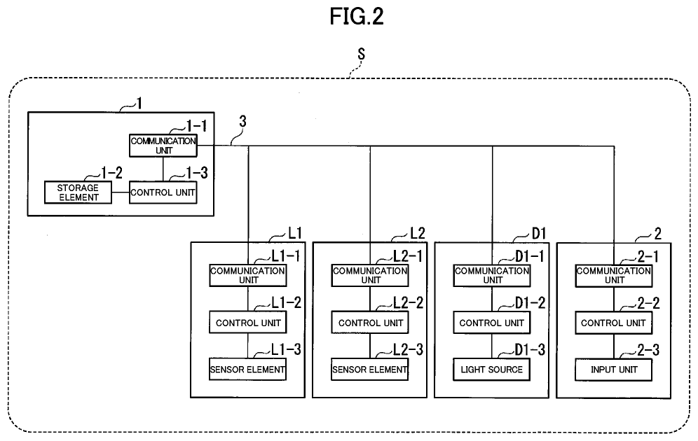

FIG. 2 is a diagram showing a configuration of the light control system S and a functional block of each component according to the present embodiment.

The lighting control unit 1 includes a communication unit 1-1, a storage element 1-2, and a control unit 1-3.

The first illuminance sensor L1 includes a communication unit L1-1, a control unit L1-2, and a sensor element L1-3.

The second illuminance sensor L2 includes a communication unit L2-1, a control unit L2-2, and a sensor element L2-3.

The first lighting device D1 includes a communication unit D1-1, a control unit D1-2, and a light source D1-3.

The setting device 2 includes a communication unit 2-1, a control unit 2-2, and an input unit 2-3.

The first illuminance sensor L1, the second illuminance sensor L2, the first lighting device D1, and the setting device 2 are connected to the lighting control unit 1 by the communication unit included in each of the above and the signal line 3.

The communication unit 1-1 of the lighting control unit 1 acquires information on the brightness at each installation place measured by the first illuminance sensor L1 and the second illuminance sensor L2, and outputs the information to the control unit 1-3. The communication unit 1-1 acquires the light output control function on/off information and the light output control information performed by the lighting control unit 1 from the setting device 2 and outputs the information to the control unit 1-3.

The control unit 1-3 may write and store the light output control function on/off information and the light output control information performed by the lighting control unit 1, which are acquired from the setting device 2, in the storage element 1-2.

The storage element 1-2 is, for example, a hard disc drive (HDD), a flash memory, an electrically erasable programmable read only memory (EEPROM), a read only memory (ROM), or a random access memory (RAM).

The sensor element L1-3 included in the first illuminance sensor L1 measures the brightness in the installation environment thereof and outputs the measured brightness to the control unit L1-2. The communication unit L1-1 acquires information on the brightness in the installation environment of the first illuminance sensor L1 from the control unit L1-2 and transmits the information to the lighting control unit 1.

The sensor element L2-3 included in the second illuminance sensor L2 measures the brightness in the installation environment thereof and outputs the measured brightness to the control unit L2-2. The communication unit L2-1 acquires information on the brightness in the installation environment of the second illuminance sensor L2 from the control unit L2-2 and transmits the information to the lighting control unit 1.

The first lighting device D1 acquires the light output control information from the lighting control unit 1 through the communication unit D1-1 and outputs the information to the control unit D1-2. The control unit D1-2 controls the intensity of light emitted from the light source D1-3 based on the light output control information acquired from the lighting control unit 1.

The light output control function on/off information, the light output control information, or the like is input to the input unit 2-3 included in the setting device 2. The control unit 2-2 acquires the light output control function on/off information or the light output control information input to the input unit 2-3 and outputs the information to the communication unit 2-1. The communication unit 2-1 transmits the light output control function on/off information and the light output control information to the lighting control unit 1.

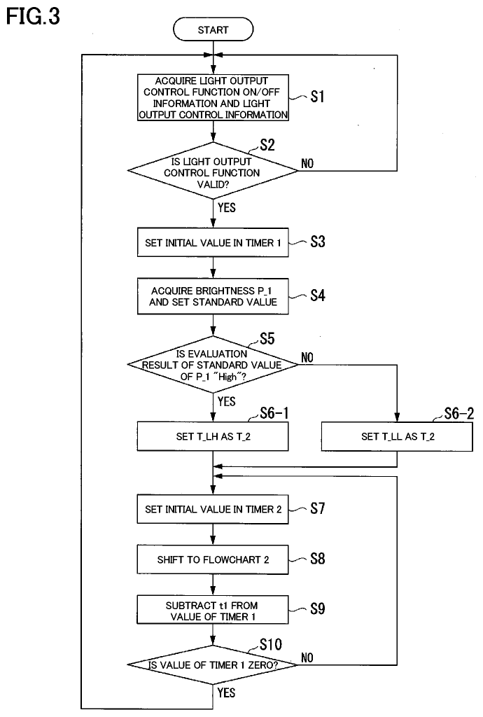

Next, an operation sequence of the light control system S in a case where the light output control function is valid will be described. FIG. 3 is a flowchart 1 showing a state transition of the lighting control unit 1 when the light control system S operates.

<Step S1>

The lighting control unit 1 acquires the light output control function on/off information and the light output control information input to the setting device 2 from the setting device 2, and shifts to step S2.

In the present embodiment, for example, the light output control information includes a target illuminance setting cycle (t_con1), a dimming time (t_con2), timer 1 subtraction granularity (t1), timer 2 subtraction granularity (t2), and a maximum brightness value (P_max), a minimum brightness value (P_min), a brightness threshold value parameter (α_P), a target illuminance 1 (T_LH), a target illuminance 2 (T_LL), a light output control speed (R_P), and an allowable fluctuation amount (F_T). Here, T_LH>T_LL.

Here, P_max and P_min have unique values for each time point, and the values may be different or may be the same for each time point.

<Step S2>

The lighting control unit 1 determines whether or not the light output control function is valid based on the light output control function on/off information. In a case where the light output control function is valid, the state of the lighting control unit 1 shifts to step S3. In a case where the light output control function is invalid, the state of the lighting control unit 1 shifts to step S1.

<Step S3>

The lighting control unit 1 sets a time based on the target illuminance setting cycle (t_con1) as an initial value in a timer 1 included inside the control unit 1-3, and the state of the lighting control unit 1 shifts to step S4.

<Step S4>

The lighting control unit 1 acquires brightness (P_1) acquired from the first illuminance sensor L1. The lighting control unit 1 reads values of the brightness P_1 for the past one cycle from the storage element 1-2 and sets a standard value (P_std1) of the brightness P_1 based on the values of the brightness P_1. For example, the standard value (P_std1) of the brightness P_1 may be a number average of the measured values of the brightness P_1 for the past one cycle.

The values of the brightness P_1 for the past one cycle are, for example, measured values of the brightness P_1 corresponding to values until (timer 1, timer 2) changes from a state of (t_con1, t_con2) to (0, 0) as described below, and are read from the storage element 1-2 by the lighting control unit 1. In this case, there are (t_con1÷t1)×(t_con2÷t2) times of the measured values of the brightness P_1. The standard value P_std1 of the brightness P_1 may be set based on the number average or may be set based on the minimum value and the maximum value of the measured values.

In a case where the values of the brightness P_1 for the past one cycle are not stored in the storage element 1-2 or the like, current brightness P_1 may be set as the standard value (P_std1) as necessary. Thereafter, the state of the lighting control unit 1 shifts to step S5.

<Step S5>

The lighting control unit 1 evaluates the standard value P_std1 of the brightness (P_1) acquired from the first illuminance sensor L1 and sets a target value (T_2) of the brightness measured by the second illuminance sensor L2 based on the evaluation result.

The evaluation of the standard value P_std1 of the brightness P_1 performed by the lighting control unit 1 is specifically to determine whether P_std1 is equal to or larger than P_max−(P_max−P_min)×α_P or P_std1 is less than P_max−(P_max−P_min)×α_P. The lighting control unit 1 may evaluate the standard value P_std1 of the brightness P_1 based on any one of P_max or P_min or both P_max and P_min.

In a case where P_std1 is equal to or larger than P_max−(P_max−P_min)×α_P, the lighting control unit 1 determines that the standard value P_std1 of the brightness P_1 is “High”. In this case, the state of the lighting control unit 1 shifts to step S6-1.

In a case where P_std1 is less than P_max−(P_max−P_min)×α_P, the lighting control unit 1 determines that the standard value P_std1 of the brightness P_1 is not “High”. In this case, the state of the lighting control unit 1 shifts to step S6-2.

<Step S6-1>

The lighting control unit 1 sets T_LH as T_2 and shifts to step S7.

<Step S6-2>

The lighting control unit 1 sets T_LL as T_2 and shifts to step S7.

<Step S7>

The lighting control unit 1 sets a time based on the dimming time (t_con2) as an initial value in a timer 2 included inside the control unit 1-3 and shifts to step S8.

<Step S8>

The lighting control unit 1 shifts to an operation of a flowchart 2. The operation of the flowchart 2 will be described below.

<Step S9>

The lighting control unit 1 subtracts the value of the timer 1 by t1, and the state of the lighting control unit 1 shifts to step S10.

<Step S10>

The lighting control unit 1 monitors the value of the timer 1. In a case where the value of the timer 1 is zero, the state of the lighting control unit 1 shifts to step S1. In a case where the timer value is not zero, the state of the lighting control unit 1 shifts to step S7.

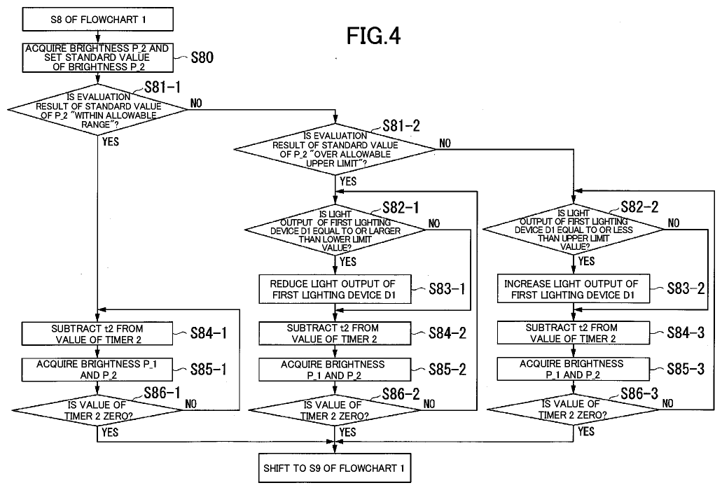

Next, an operation when the lighting control unit 1 controls the intensity of the light emitted from the light sources D1-3 based on the light output control information will be described based on the flowchart 2. FIG. 4 is a flowchart 2 in the present embodiment.

<Step S80>

The lighting control unit 1 acquires brightness P_2. The lighting control unit 1 reads values of the brightness P_2 for the past one cycle from the storage element 1-2 and sets a standard value (P_std2) of the brightness P_2 based on the values of the brightness P_2. For example, the standard value (P_std2) of the brightness P_2 may be a number average of the measured values of the brightness P_2 for the past one cycle.

The values of the brightness P_2 for the past one cycle are, for example, measured values of the brightness P_2 corresponding to values until the value of the timer 2 changes from t_con2 to 0, and are read from the storage element 1-2 by the lighting control unit 1. In this case, there are t_con2÷t2 times of the measured values of the brightness P_2. The standard value P_std2 of the brightness P_2 may be set based on the number average or may be set based on the minimum value and the maximum value of the measured values.

Alternatively, in a case where the values of the brightness P_2 for the past one cycle are not stored in the storage element 1-2 or the like, current brightness P_2 may be set as the standard value (P_std2) as necessary. Thereafter, the lighting control unit 1 shifts to step S81-1.

<Step S81-1>

The lighting control unit 1 evaluates the brightness (P_2). The evaluation of the brightness (P_2) performed by the lighting control unit 1 is to determine whether or not the standard value (P_std2) of P_2 set in step S80 is within the allowable fluctuation amount (F_T) with reference to a target value T_2.

For example, in a case where P_std2 is larger than T_2×(1+F_T), the lighting control unit 1 determines that the standard value P_std2 is “over allowable upper limit”.

Alternatively, in a case where P_std2 is less than T_2÷(1+F_T), the lighting control unit 1 determines that the standard value P_std2 is “less than allowable lower limit”.

In a case where the value of the standard value P_std2 is within the allowable fluctuation amount (F_T) with reference to the target value T_2, the state of the lighting control unit 1 shifts to step S84-1.

In a case where the value of the standard value P_std2 is not within the allowable fluctuation amount (F_T) with reference to the target value T_2, the state of the lighting control unit 1 shifts to step S81-2.

<Step S81-2>

The lighting control unit 1 shifts to step S82-1 in a case where the evaluation result of the standard value P_std2 is over the allowable upper limit.

The lighting control unit 1 shifts to step S82-2 in a case where the evaluation result of the standard value P_std2 is equal to or less than the allowable upper limit. In step S81-2, the case where the evaluation result of the standard value P_std2 is equal to or less than the allowable upper limit is the case where the evaluation result of the standard value P_std2 is less than the allowable lower limit. This is because the lighting control unit 1 shifts to step S81-2 in the case where the evaluation result of the standard value P_std2 in step S81-1 is outside an allowable range.

<Step S82-1>

The lighting control unit 1 shifts to step S83-1 in a case where a light output of the first lighting device D1 is equal to or larger than a lower limit value.

In a case where the light output of the first lighting device D1 is less than the lower limit value, the lighting control unit 1 determines that the light output cannot be further reduced and shifts to step S84-2.

<Step S82-2>

The lighting control unit 1 shifts to step S83-2 in a case where the light output of the first lighting device D1 is equal to or less than an upper limit value.

In a case where the light output of the first lighting device D1 is larger than the upper limit value, the lighting control unit 1 determines that the light output cannot be further increased and shifts to step S84-3.

<Step S83-1>

The lighting control unit 1 transmits the light output control speed (R_P) and a control signal to reduce the light output to the first lighting device D1 such that the light output emitted from the first lighting device D1 is reduced and falls within the allowable fluctuation amount.

The light output control speed is an amount of change in the light output per unit time. The lighting control unit 1 may transmit a value with a negative sign added as the light output control speed (R_P) to the first lighting device D1 to represent the control signal to reduce the light output. Thereafter, the lighting control unit 1 shifts to step S84-2.

<Step S83-2>

The lighting control unit 1 transmits the light output control speed (R_P) and a control signal to increase the light output to the first lighting device D1 such that the light output emitted from the first lighting device D1 is increased and falls within the allowable fluctuation amount. The lighting control unit 1 may transmit a value with a positive sign added as the light output control speed (R_P) to the first lighting device D1 to represent the control signal to increase the light output. Thereafter, the lighting control unit 1 shifts to step S84-3.

<Steps S84-1, S84-2, and S84-3>

The lighting control unit 1 subtracts t1 from the value of the timer 2 and shifts from step S84-1 to step S85-1, from step S84-2 to step S85-2, and from step S84-3 to step S85-3, respectively.

<Steps S85-1, S85-2, and S85-3>

The lighting control unit 1 acquires the brightness P_1 and P_2, and stores the values of the brightness P_1 and P_2 in the storage element 1-2, respectively, as the brightness according to the value of the timer 2 at the point of time. Thereafter, the lighting control unit 1 shifts from step S85-1 to step S86-1, from step S85-2 to step S86-2, and from step S85-3 to step S86-3, respectively.

<Steps S86-1, S86-2, and S86-3>

The lighting control unit 1 monitors the value of the timer 2. In a case where the value of the timer 2 is zero, the state of the lighting control unit 1 shifts to step S9 of the flowchart 1. In a case where the timer value is not zero, the lighting control unit 1 shifts from step S86-1 to step S84-1, from step S86-2 to step S82-1, and from step S86-3 to step S82-2, respectively.

In both cases of steps S83-1 and S83-2, the first lighting device D1 receives the light output control speed (R_P) from the lighting control unit 1 through the communication unit D1-1. The first lighting device D1 controls the light output emitted from the light sources D1-3 at the speed of R_P based on the information whether to increase the light output or reduce the light output.

Next, an operation example of the light control system S will be described in detail.

In the present embodiment, it is assumed that the light output control information input to the setting device 2 has the target illuminance setting cycle (t_con1) of two dimming cycles, the dimming time (t_con2) of five seconds, the timer 1 subtraction granularity (t1) of one time, the timer 2 subtraction granularity (t2) of one second, the brightness threshold value parameter (α_P) of 0.5, the target illuminance 1 (T_LH) is 850 lx, the target illuminance 2 (T_LL) is 650 lx, the light output control speed (R_P) of four lumens/second, and the target setting parameter fluctuation allowance (F_T) of 0.1.

The dimming cycle is a period from the transition of the lighting control unit 1 to the flowchart 2 to the exit from the flowchart 2.

When the maximum brightness value (P_max) and the minimum brightness value (P_min) included in the light output control information are set, the values may be set based on a log when the brightness is measured in the past or the like, for example.

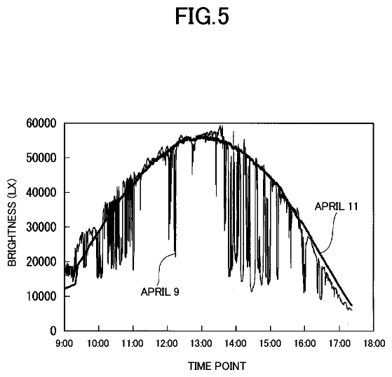

FIG. 5 shows an example of a temporal change in brightness when the first illuminance sensor L1 continuously measures the brightness during the daytime. The horizontal axis represents time point, the vertical axis represents brightness, and the unit is lx.

For example, it is assumed that the light control system S is operated on April 10 of a certain year. It is assumed that the temporal changes in brightness measured by the first illuminance sensor L1 at the same place on April 9 and April 11 of the previous year thereof are shown in FIG. 5.

It is assumed that April 9 is a sunny and sometimes cloudy day while April 11 is a clear day for all day. From FIG. 5, it can be seen that there are many time zones in which the brightness fluctuates greatly in the short term on April 9. It is considered that this is because the solar irradiance is affected by a fluctuation in a cloud amount and movement of the cloud. On the other hand, it can be seen that there is little short-term fluctuation in brightness on April 11 when it is a clear day, unlike on April 9.

From the results of FIG. 5, it is shown that the maximum value and the minimum value of the brightness during the daytime at around 14:10 in the same period of the previous year are approximately 55,000 lx and 14,000 lx, respectively, from the measurement results of the brightness on two different days in the same period of the previous year.

It can be seen that P_max and P_min are approximately 30,000 lx and 10,000 lx, respectively, at around 16:00.

For example, it is assumed that the values of 55,000 lx and 14,000 lx are respectively input to the setting device 2 as P_max and P_min based on the results shown in FIG. 5 when the light control system S is operated at around 14:10.

In this case, the calculation result of P_max−(P_max−P_min)×α_P is 34,500 lx. Therefore, in a case where the brightness (P_1) measured by the first illuminance sensor L1 is 34,500 lx or more, the lighting control unit 1 sets 850 lx as the value of the target value 1 (T_LH). In a case where the brightness (P_1) measured by the first illuminance sensor L1 is less than 34,500 lx, the lighting control unit 1 sets 650 lx as the target value 2 (T_LL).

Next, the operation of the light control system S when P_max and P_min are set as described above will be described in detail.

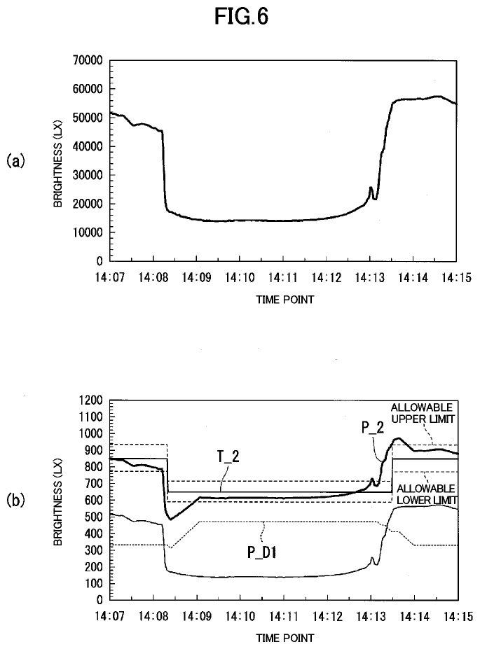

FIG. 6A shows a temporal change in brightness measured by the first illuminance sensor L1 from 14:07 to 14:15.

FIG. 6B shows temporal changes of the target value (T_2) of the brightness measured by the second illuminance sensor L2, the measured value of the brightness (P_2) by the second illuminance sensor L2, and the light output (P_D1) emitted from the first lighting device D1 in the same time zone. In both of FIGS. 6A and 6B, the horizontal axis represents time point, the vertical axis represents brightness, and the unit is lx.

As shown in FIG. 6A, the lighting control unit 1 acquires information, from the storage element 1-2, that the brightness measured by the first illuminance sensor L1 is 49,900 lx, 49,800 lx, 49,800 lx, 49,700 lx, 49,700 lx, 49,700 lx, 49,600 lx, 49,500 lx, 49,500 lx, and 49,300 lx, respectively, at each time one second elapses from 14:07 to 14:07:09.

The lighting control unit 1 sets, as the standard value P_std1 of the brightness 1, 49,650 lx which is an average value of the brightness for 10 seconds from dimming cycle 2 times×dimming time 5 seconds.

Therefore, the lighting control unit 1 sets 850 lx of T_LH as the target value (T_2) of the brightness measured by the second illuminance sensor L2 at the point of time of 14:07:10. The lighting control unit 1 controls the light output of the first lighting device D1 such that the brightness measured by the second illuminance sensor L2 falls within the allowable fluctuation amount (F_T) with reference to the target value (T_LH) of 850 lx.

Next, as shown in FIG. 6A, the lighting control unit 1 acquires information, from the storage element 1-2, that the brightness (P_1) measured by the first illuminance sensor L1 is 44,500 lx, 44,300 lx, 43,700 lx, 41,900 lx, 38,400 lx, 29,600 lx, 24,200 lx, 21,800 lx, 19,100 lx, and 18,000 lx, respectively, at each time one second elapses from 14:08 to 14:08:09.

The lighting control unit 1 sets, as the standard value P_std1 of the brightness 1, 32,550 lx which is an average value of the brightness for 10 seconds at the point of time of 14:08:10.

The lighting control unit 1 changes the target value (T_2) of the brightness measured by the second illuminance sensor L2 to 650 lx of T_LL as P_1 decreases, as shown in FIG. 6B. The lighting control unit 1 controls the light output of the first lighting device D1 such that the brightness measured by the second illuminance sensor L2 falls within the allowable fluctuation amount (F_T) with reference to the target value (T_LL) of 650 lx.

As shown in FIG. 6B, the light output (P_D1) emitted from the first lighting device D1 increases in proportion to time as the target value (T_2) of the brightness is changed, and the increase in P_D1 is stopped when the dimming time (t_2) elapses. The brightness control for the first lighting device D1 may be stopped when the brightness measured by the second illuminance sensor L2 reaches within the allowable fluctuation amount based on the target value (T_LL) without necessarily waiting for the dimming time (t_2) to elapse.

Next, as shown in FIG. 6A, the lighting control unit 1 acquires information, from the storage element 1-2, that the brightness (P_1) measured by the first illuminance sensor L1 is 18,460 lx, 19,460 lx, 21,460 lx, 24,460 lx, 32,555 lx, 41,445 lx, 49,000 lx, 50,000 lx, 50,500 lx, and 50,800 lx, respectively, at each time one second elapses from 14:13 to 14:13:09.

The lighting control unit 1 sets, as the standard value P_std1 of the brightness 1, 35,814 lx which is an average value of the brightness for 10 seconds at the point of time of 14:13:10.

The lighting control unit 1 changes the target value (T_2) of the brightness measured by the second illuminance sensor L2 to 850 lx of T_LH as P_1 increases, as shown in FIG. 6B. The lighting control unit 1 controls the light output of the first lighting device D1 such that the brightness measured by the second illuminance sensor L2 falls within the allowable fluctuation amount around the target value (T_LH) of 850 lx.

As shown in FIG. 6B, the light output (P_D1) emitted from the first lighting device D1 decreases in proportion to time as the target value (T_2) of the brightness is changed, and the decrease in P_D1 is stopped when the dimming time (t_2) elapses. The brightness control for the first lighting device D1 may be stopped when the brightness measured by the second illuminance sensor L2 reaches within the allowable fluctuation amount based on the target value (T_LL) without necessarily waiting for the dimming time (t_2) to elapse.

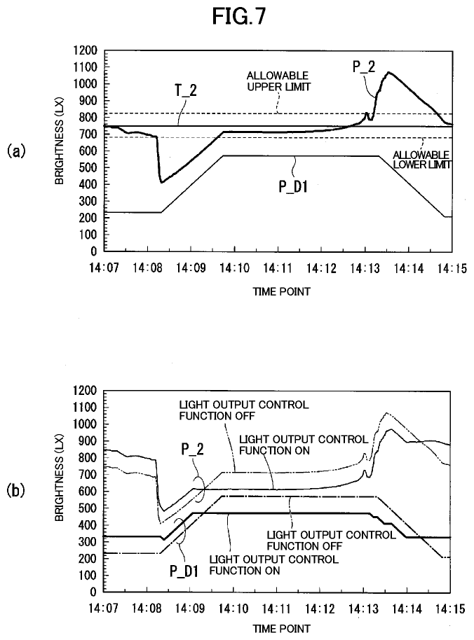

For comparison, in the related art, that is, in the lighting control system S, an operation in a case where the light output control function is off, and the lighting control unit 1 does not change the target value of the brightness measured by the second illuminance sensor L2 according to the brightness measured by the first illuminance sensor L1 will be described. FIG. 7A shows temporal changes of the target value (T_2) of the brightness measured by the second illuminance sensor L2, the measured value of the brightness (P_2) by the second illuminance sensor L2, and the light output (P_D1) emitted from the first lighting device D1 in a case where the light output control function is off in the lighting control system S. It is assumed that operating conditions are the same as those in the first embodiment except that the light output control function is off.

FIG. 7B shows temporal changes of the measured value of the brightness (P_2) by the second illuminance sensor L2 and the light output (P_D1) emitted from the first lighting device D1 in the first embodiment, that is, in a case where the light output control function is on and in a case where the light output control function is off. In both of FIGS. 7A and 7B, the horizontal axis represents time, the vertical axis represents brightness, and the unit is lx. From FIG. 7B, as in the present embodiment, it can be seen that the lighting control unit 1 changes the target value of the brightness measured by the second illuminance sensor L2 according to the brightness measured by the first illuminance sensor L1 and thus it is possible to suppress amounts of fluctuation in the measured value of the brightness (P_2) by the second illuminance sensor L2 and the light output (P_D1) emitted from the first lighting device D1.

As described above, in a case where the brightness measured by the first illuminance sensor L1 is higher than predetermined brightness, the lighting control unit 1 changes the target value of the brightness measured by the second illuminance sensor L2 to a high value.

Accordingly, as shown in FIG. 7B, a difference between the current brightness and the target value becomes small as compared with the case where the target value of the brightness measured by the second illuminance sensor L2 is constant. Therefore, it is possible to shorten a time relating to the control of the brightness.

In a case where the brightness measured by the first illuminance sensor L1 is lower than the predetermined brightness, the lighting control unit 1 changes the target value of the brightness measured by the second illuminance sensor L2 to a low value.

Accordingly, as shown in FIG. 7B, the difference between the current brightness and the target value becomes small as compared with the case where the target value of the brightness measured by the second illuminance sensor L2 is constant. Therefore, it is possible to shorten the time relating to the control of the brightness.

As shown in FIG. 7B, the lighting control unit 1 changes the target value of the brightness measured by the second illuminance sensor L2 according to the brightness measured by the first illuminance sensor L1. Therefore, the fluctuation in the brightness becomes small.

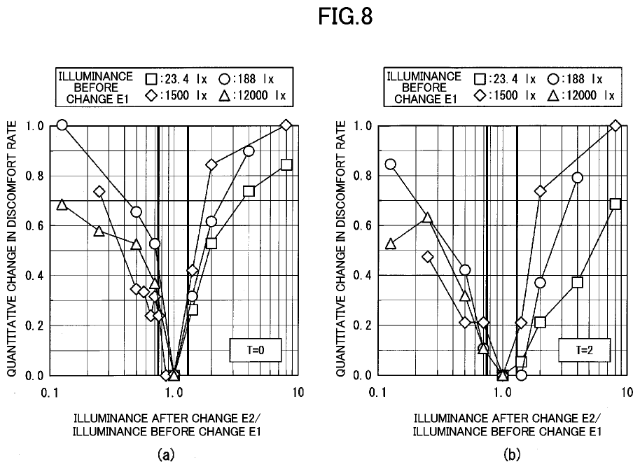

FIGS. 8A and 8B show results of evaluating a discomfort rate felt by a predetermined number of persons (visual workers) who perform visual work in the work environment E when the brightness is changed for a predetermined time in the work environment E. Each of FIGS. 8A and 8B shows a relationship between the discomfort rate and a rate of change in brightness in a case where the brightness is changed instantaneously and for two seconds in the work environment E. In FIGS. 8A and 8B, the vertical axis represents discomfort rate and the horizontal axis represents rate of change in brightness. In the present embodiment, the discomfort rate is a ratio of the number of visual workers who feel uncomfortable to the total number of visual workers in a case where the brightness is changed.

In FIG. 8A, for example, a region on the left side shows a case where the brightness is instantaneously reduced. Each plot shows a result of the discomfort rate when the brightness before reducing the brightness (dimming) is different and the brightness before the dimming is 188 lx, 1,500 lx, and 12,000 lx, respectively. In FIG. 8A, it can be seen that the discomfort rate tends to increase as a ratio of illuminance after change to illuminance before change becomes closer to 0.1 and the discomfort rate tends to increase as the brightness before the dimming becomes lower.

In FIG. 8A, for example, a region on the right side shows a case where the brightness is instantaneously increased. Each plot shows a result of the discomfort rate when the brightness before increasing the brightness (brightening) is different and the brightness before the brightening is 23.4 lx, 188 lx, and 1,500 lx, respectively. In FIG. 8A, it can be seen that the discomfort rate tends to increase as the ratio of illuminance after change to illuminance before change becomes closer to 10 and the discomfort rate tends to increase as the brightness before the brightening becomes higher.

FIG. 8B shows the relationship between the discomfort rate and the rate of change in brightness in a case where the brightness is reduced or increased over two seconds. Similarly to the case of FIG. 8A, at the time of dimming, it can be seen that the discomfort rate tends to decrease as the brightness before the dimming becomes higher and the discomfort rate tends to decrease as the brightness before the brightening becomes lower.

Therefore, as shown in FIG. 7B, the brightness P_2 measured by the second illuminance sensor L2 suddenly becomes dark at around 14:08. However, according to one aspect of the present invention, the brightness before the dimming can be higher as compared with the case where the target value of the brightness P_2 is constant. Therefore, it can be seen that it is possible to control the brightness without damaging the comfort of the visual worker as shown in FIGS. 8A and 8B.

As shown in FIG. 7B, the brightness P_2 measured by the second illuminance sensor L2 suddenly becomes bright at around 14:13. However, according to one aspect of the present invention, the brightness before the brightening can be lower as compared with the case where the target value of the brightness P_2 is constant. Therefore, it can be seen that it is possible to control the brightness without damaging the comfort of the visual worker as shown in FIGS. 8A and 8B.

A time interval for reviewing the target illuminance of the brightness P_2 based on the brightness P_1 is made longer than the dimming time, that is, longer than the time to control the light output emitted from the first lighting device D1. With this, it is possible to stably control the brightness without frequently changing the target value of the brightness P_2 even in a case where the brightness P_1 fluctuates greatly in the short term, such as on a cloudy day.

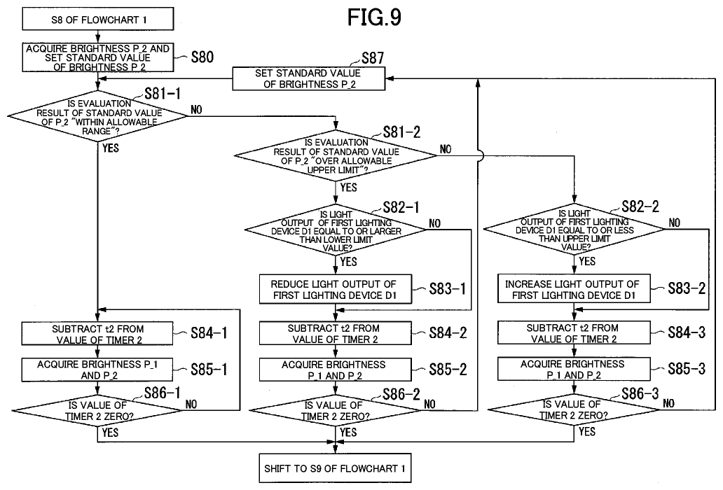

In the present embodiment, the operation of controlling the light output (P_D1) emitted from the first lighting device D1 has been described based on the flowchart 2. In this case, once the brightening or the dimming is started, the lighting control unit 1 continues to control the light output until the value of the timer 2 becomes zero. A modification example of the present embodiment will be described using a flowchart 2′ shown in FIG. 9.

FIG. 9 is the flowchart 2′ relating to the modification example of the present embodiment. A difference from the flowchart 2 is that the operation in the conditional branch in steps S86-2 and S86-3 and step S87 is newly added. The difference from the flowchart 2 will be described.

<Steps S86-2 and S86-3>

The lighting control unit 1 monitors the value of the timer 2. In a case where the value of the timer 2 is zero, the state of the lighting control unit 1 shifts to step S8 of the flowchart 1. In a case where the timer value is not zero, the lighting control unit 1 shifts from steps S86-2 and S86-3 to step S87, respectively.

<Step S87>

The lighting control unit 1 acquires the brightness P_2 corresponding to the current value of the timer 2 from the storage element 1-2 and sets the brightness as the standard value (P_std2) of the brightness P_2. Thereafter, the lighting control unit 1 shifts to step S81-1.

In the modification example of the first embodiment, when the lighting control unit 1 controls the light output (P_D1) emitted from the first lighting device D1, the control of the light output (P_D1) emitted from the first lighting device D1 is stopped once the brightness P_2 measured by the second illuminance sensor enters within the allowable range. On the contrary, in the first embodiment, the control of the light output (P_D1) emitted from the first lighting device D1 continues until the value of the timer 2 becomes zero. Therefore, in a case where a dimming speed is high, the dimming time t_con2 is long, the short-term fluctuation amount of the brightness P_1 is large, or the like, the control may be continued while the brightness P_2 is out of the allowable range.

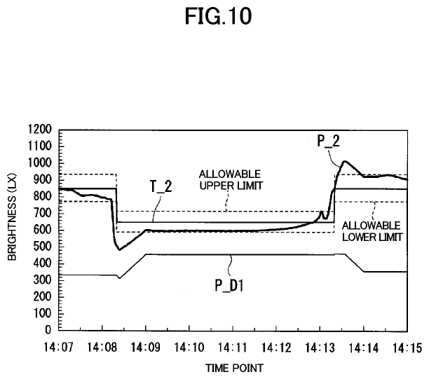

Next, the operation of the light control system S based on the flowchart 2′ will be described in detail. The operating conditions are the same as those in the first embodiment. For example, the temporal change in the brightness measured by the first illuminance sensor L1 is as shown in FIG. 6A. FIG. 10 shows temporal changes of the target value (T_2) of the brightness measured by the second illuminance sensor L2, the measured value of the brightness (P_2) by the second illuminance sensor L2, and the light output (P_D1) emitted from the first lighting device D1 in the same time zone. In FIG. 10, the horizontal axis represents time, the vertical axis represents brightness, and the unit is lx. In FIG. 10, it is assumed that the operation based on the flowchart 2′ shown in FIG. 9 is performed when the lighting control unit 1 controls the light output (P_D1) emitted from the first lighting device D1.

Next, as shown in FIG. 6A, the lighting control unit 1 acquires information, from the storage element 1-2, that the brightness (P_1) measured by the first illuminance sensor L1 is 44,500 lx, 44,300 lx, 43,700 lx, 41,900 lx, 38,400 lx, 29,600 lx, 24,200 lx, 21,800 lx, 19,100 lx, and 18,000 lx, respectively, at each time one second elapses from 14:08 to 14:08:09.

The lighting control unit 1 sets, as the standard value P_std1 of the brightness 1, 32,550 lx which is an average value of the brightness for 10 seconds at the point of time of 14:08:10.

The lighting control unit 1 changes the target value (T_2) of the brightness measured by the second illuminance sensor L2 to 650 lx of T_LL as P_1 decreases, as shown in FIG. 10. The lighting control unit 1 controls the light output of the first lighting device D1 such that the brightness measured by the second illuminance sensor L2 falls within the allowable fluctuation amount (F_T) with reference to the target value (T_LL) of 650 lx.

As shown in FIG. 10, the light output (P_D1) emitted from the first lighting device D1 increases in proportion to time as the target value (T_2) of the brightness is changed, and the lighting control unit 1 stops the brightening control of the first lighting device D1 when the brightness measured by the second illuminance sensor L2 reaches within the allowable fluctuation amount based on the target value (T_LL) at around 14:08:30.

In the modification example of the first embodiment, when the lighting control unit 1 controls the light output (P_D1) emitted from the first lighting device D1, the control of the light output (P_D1) emitted from the first lighting device D1 is stopped once the brightness P_2 measured by the second illuminance sensor enters within the allowable range. Therefore, even in the case where the dimming speed is high, the dimming time t_con2 is long, the short-term fluctuation amount of the brightness P_1 is large, or the like, it is possible to keep the brightness P_2 within the allowable range.

### Summary of First Embodiment

As described above, in the present embodiment, the lighting control unit 1 acquires the brightness information (P_1) measured by the first illuminance sensor L1 through the signal line 3 and sets the information as the standard value (P_std1) of the brightness P_1. The lighting control unit 1 performs the evaluation by comparing the set value of P_std1 with predetermined brightness. The lighting control unit 1 changes the target value (T_2) of the brightness of the installation environment of the second illuminance sensor L2 based on the evaluation result.

For example, in a case where the set value of P_std1 is higher than the predetermined brightness, the lighting control unit 1 changes T_2 to a high value (T_LH). Accordingly, it is possible to suppress a dimming amount of the brightness of the first lighting device D1 as compared with the case where the target value of the brightness measured by the second illuminance sensor L2 is constant. In other words, since the difference between the current brightness and the target value becomes small, it is possible to shorten the time relating to the control of the brightness. It is possible to increase the minimum value when the light output emitted from the first lighting device D1 is reduced as compared with the case where the target value of the brightness measured by the second illuminance sensor L2 is constant. Therefore, it is possible to suppress the amount of fluctuation in brightness when the light control is performed.

In a case where the set value of P_std1 is lower than the predetermined brightness, the lighting control unit 1 changes T_2 to a low value (T_LL).

Accordingly, it is possible to suppress the brightening amount of the brightness of the first lighting device D1 as compared with the case where the target value of the brightness measured by the second illuminance sensor L2 is constant. In other words, since the difference between the current brightness and the target value becomes small, it is possible to shorten the time relating to the control of the brightness. It is possible to reduce the maximum value when the light output emitted from the first lighting device D1 is increased as compared with the case where the target value of the brightness measured by the second illuminance sensor L2 is constant. Therefore, it is possible to suppress the amount of fluctuation in brightness when the light control is performed.

From the above, the amount of fluctuation in brightness is suppressed and thus it is possible to reduce the discomfort felt by a person who performs the visual work in the work environment E.

The lighting control unit 1 acquires the brightness (P_2) measured by the second illuminance sensor L2 from the second illuminance sensor L2 through the signal line 3 and sets the brightness as the standard value (P_std2) of the brightness P_2. In a case where the set P_std2 does not fall within the allowable fluctuation amount (F_T) with reference to the set target value (T_2) of the brightness, the lighting control unit 1 increases or reduces the light output of the first lighting device D1 such that the set P_std2 falls within the allowable fluctuation amount.

The lighting control unit 1 acquires the brightness information (P_1) at the installation place measured by the first illuminance sensor L1 through the signal line 3 and sets the information as the standard value (P_std1) of the brightness P_1. The lighting control unit 1 performs the evaluation by comparing the set value of P_std1 with predetermined brightness based on a past measurement log.

The lighting control unit 1 changes the target value (T_2) of the brightness near the installation place of the second illuminance sensor L2 based on the evaluation result.

At the time, for example, in a case where the set value of P_std1 is higher than the predetermined brightness, the lighting control unit 1 predicts that the value of P_1 is likely to be lower than the current value. In other words, the lighting control unit 1 predicts that there is a high possibility of performing control to increase the brightness of the first lighting device D1.

In a case where the set value of P_std1 is higher than the predetermined brightness, the lighting control unit 1 changes T_2 to a high value (T_LH).

Accordingly, it is possible to suppress the amount of fluctuation in brightness when the light output of the first lighting device D1, which is a control target of the lighting control device 1, is increased as compared with the case where the target value of the brightness measured by the second illuminance sensor L2 is constant.

The lighting control unit 1 acquires the brightness information (P_1) at the installation place measured by the first illuminance sensor L1 through the signal line 3 and sets the information as the standard value (P_std1) of the brightness P_1. The lighting control unit 1 performs the evaluation by comparing the set value of P_std1 with the predetermined brightness based on the past measurement log. The lighting control unit 1 changes the target value (T_2) of the brightness near the installation place of the second illuminance sensor L2 based on the evaluation result.

At the time, for example, in a case where the set value of P_std1 is lower than the predetermined brightness, the lighting control unit 1 predicts that the value of P_1 is likely to be higher than the current value. In other words, the lighting control unit 1 predicts that there is a high possibility of performing control to reduce the brightness of the first lighting device D1.

In a case where the set value of P_std1 is lower than the predetermined brightness, the lighting control unit 1 changes T_2 to a low value (T_LL).

Accordingly, it is possible to suppress the amount of fluctuation in brightness when the light output of the first lighting device D1, which is the control target of the lighting control device 1, is reduced as compared with the case where the target value of the brightness measured by the second illuminance sensor L2 is constant.

According to one aspect of the present invention, in a case where the brightness is reduced in the work environment E, it is possible to brighten the brightness before the dimming as compared with the case where the target value of the brightness P_2 is constant. Therefore, it is possible to control the brightness without damaging the comfort of the visual worker.

According to one aspect of the present invention, in a case where the brightness is increased in the work environment E, it is possible to darken the brightness before the brightening as compared with the case where the target value of the brightness P_2 is constant. Therefore, it is possible to control the brightness without damaging the comfort of the visual worker.

In the present embodiment, the lighting control unit 1 sets T_LL to 650 lx and T_LH to 850 lx as the target value (T_2) of the brightness, but the present invention is not limited thereto. For example, the lighting control unit 1 may set T_LL to a value of 500 lx or more and T_LH to a value of 1,000 lx or less.

It is possible to set values as necessary for the target illuminance setting cycle (t_con1), the dimming time (t_con2), the maximum brightness value (P_max), the minimum brightness value (P_min), the brightness threshold value parameter (α_P), the light output control speed (R_P), and the target setting parameter fluctuation allowance (F_T), and the like.

The light control system S includes at least the first illuminance sensor L1 and the lighting control unit 1, and the first illuminance sensor L1 performs the measurement using the brightness of outdoor light taken into the room from the daylighting device 4. The first lighting device D1 is installed indoors and changes the emitted light output based on the light output control information received from the lighting control unit 1.

### Second Embodiment

Next, a second embodiment of the present invention will be described.

In the second embodiment, a case will be described in which the target value of the second illuminance sensor L2 is changed over three values of T_LH, T_LM, and T_LL based on the brightness (P_1) measured by the first illuminance sensor L1.

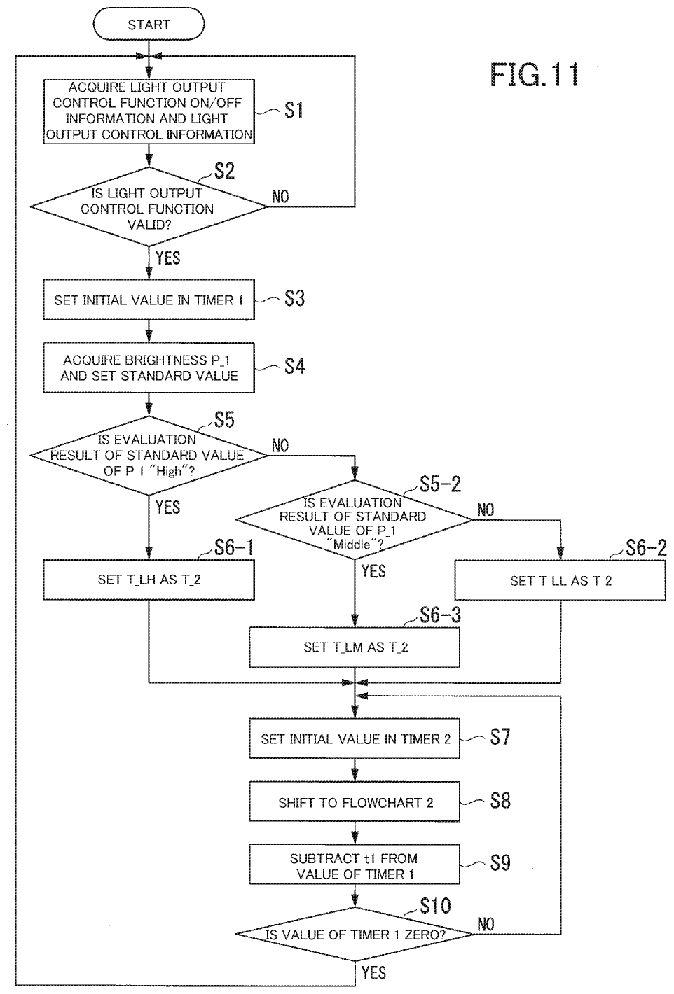

An operation sequence of the light control system S in the second embodiment will be described. FIG. 11 is a flowchart 1 showing a state transition of the lighting control unit 1 when the light control system S according to the present embodiment operates.

The operations up to step S4 and after steps S6-1, S6-2, and S7 are the same as those in the first embodiment. However, the operation is different in which the lighting control unit 1 evaluates the brightness P_1 measured by the first illuminance sensor L1 and the lighting control unit 1 sets the target value (T_2) of the second illuminance sensor L2 in steps S5, S5-2, and S6-3. Similarly to the first embodiment, it is assumed that the target value of the brightness P_2 is changed based on the average value of the measured values of the brightness P_1 for the past one cycle. The functions of other components are the same as those of the first embodiment. The description of the same functions as those in the first embodiment will be omitted.

<Step S5>

The lighting control unit 1 evaluates the standard value P_std1 set based on the brightness (P_1) acquired from the first illuminance sensor L1 and sets the target value (T_2) of the brightness measured by the second illuminance sensor L2 based on the result.

The evaluation of the standard value P_std1 of the brightness P_1 performed by the lighting control unit 1 is specifically to determine whether P_std1 is equal to or larger than P_max−(P_max−P_min)×α_P, equal to or larger than P_max−(P_max−P_min)×(1−α_P) and less than P_max−(P_max−P_min)×α_P, or less than P_max−(P_max−P_min)×(1−α_P). The lighting control unit 1 may evaluate the standard value P_std1 of the brightness P_1 based on any one of P_max or P_min or both P_max and P_min.

In a case where P_std1 is equal to or larger than P_max−(P_max−P_min)×α_P, the lighting control unit 1 determines that the brightness P_1 is “High”. In this case, the state of the lighting control unit 1 shifts to step S6-1.

In a case where the evaluation result of the brightness P_std1 is not “High”, the state of the lighting control unit 1 shifts to step S5-2.

<Step S5-2>

When P_std1 is equal to or larger than P_max−(P_max−P_min)×(1−α_P) and less than P_max−(P_max−P_min)×α_P, the lighting control unit 1 determines that the evaluation result of the standard value P_std1 of the brightness P_1 is “Middle”. In this case, the state of the lighting control unit 1 shifts to step S6-3.

In a case where the evaluation result of the standard value P_std1 of the brightness P_1 is not “Middle”, the state of the lighting control unit 1 shifts to step S6-2.

<Step S6-3>

The lighting control unit 1 sets T_LM as T_2 and shifts to step S7.

Next, in the present embodiment, an operation example of the light control system S at around 14:30 will be described in detail. Only differences from the first embodiment will be described in the present embodiment.

It is assumed that the light output control information input to the setting device 2 has the target illuminance setting cycle (t_con1) of one dimming cycle, the dimming time (t_con2) of five seconds, the timer 1 subtraction granularity (t1) is of one time, the timer 2 subtraction granularity (t2) of one second, the light output control speed (R_P) of four lumens/second, the target setting parameter fluctuation allowance (F_T) of 0.1, the target illuminance 1 (T_LH) of 850 lx, and the target illuminance 2 (T_LL) of 650 lx, the target illuminance 3 (T_LM) of 750 lx, and the brightness threshold value parameter (α_P) of 0.3.

From FIG. 5, it can be seen that P_max and P_min are respectively about 50,000 lx and about 14,000 lx at around 14:30. It is assumed that the values of 50,000 lx and 10,000 lx are respectively input to the setting device 2 as P_max and P_min when the light control system S is operated.

In this case, the lighting control unit 1 obtains a calculation result of P_max−(P_max−P_min)×α_P of 39,200 lx and a calculation result of P_max−(P_max−P_min)×(1−α_P) of 24,800 lx.

Therefore, in a case where the brightness (P_1) acquired from the storage element 1-2 is equal to or larger than 39,200 lx, the lighting control unit 1 sets 850 lx as the value of the target value 1 (T_LH). In a case where the brightness (P_1) acquired from the storage element 1-2 is equal to or larger than 24,800 lx and less than 39,200 lx, the lighting control unit 1 sets 750 lx as the value of the target value 3 (T_LM). In a case where the brightness (P_1) acquired from the first illuminance sensor L1 is less than 24,800 lx, the lighting control unit 1 sets 650 lx as the target value 2 (T_LL).

Next, the operation of the light control system S when P_max and P_min are set as described above will be described in detail. It is assumed that when the lighting control unit 1 controls the light output (P_D1) emitted from the first lighting device D1, the control of the light output (P_D1) emitted from the first lighting device D1 is stopped once the brightness P_2 measured by the second illuminance sensor enters within the allowable range based on the flowchart 2′ shown in FIG. 9 as in the modification example of the first embodiment.

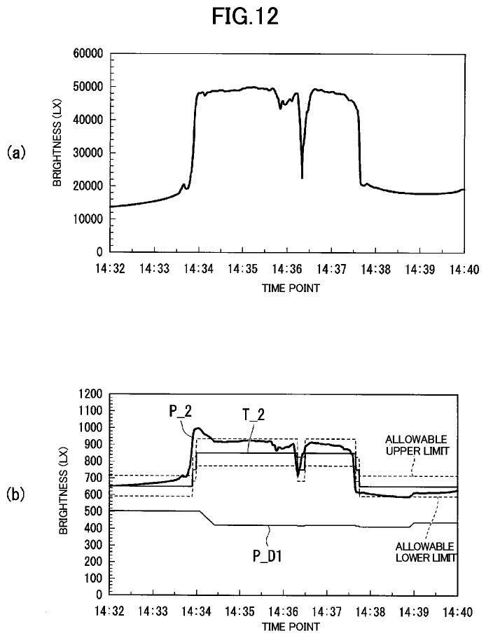

FIG. 12A shows a temporal change in brightness measured by the first illuminance sensor L1 from 14:32 to 14:40.

FIG. 12B shows temporal changes of the target value (T_2) of the brightness measured by the second illuminance sensor L2, the measured value of the brightness (P_2) by the second illuminance sensor L2, and the light output (P_D1) emitted from the first lighting device D1 in the same time zone.

In both of FIGS. 12A and 12B, the horizontal axis represents time, the vertical axis represents brightness, and the unit is lx. As shown in FIG. 12A, the lighting control unit 1 acquires information, from the storage element 1-2, that the brightness (P_1) measured by the first illuminance sensor L1 is 13,780 lx, 13,790 lx, 13,810 lx, 13,840 lx, and 13,850 lx, respectively, at each time one second elapses from 14:32:05 to 14:32:09.

The lighting control unit 1 sets, as the standard value P_std1 of the brightness 1, 13,796 lx which is an average value of the brightness for 5 seconds at the point of time of 14:32:10.

Therefore, the lighting control unit 1 sets 650 lx of T_LL as the target value (T_2) of the brightness measured by the second illuminance sensor L2 at the point of time of 14:32:10. The lighting control unit 1 controls the light output of the first lighting device D1 such that the brightness measured by the second illuminance sensor L2 falls within the allowable fluctuation amount (F_T) with reference to the target value (T_LL) of 650 lx.

As shown in FIG. 12A, the lighting control unit 1 acquires information, from the storage element 1-2, that the brightness (P_1) measured by the first illuminance sensor L1 is 24,500 lx, 26,800 lx, 29,700 lx, 33,300 lx, and 39,800 lx, respectively, at each time one second elapses from 14:33:50 to 14:33:54.

The lighting control unit 1 sets, as the standard value P_std1 of the brightness 1, 30,820 lx which is an average value of the brightness for 5 seconds at the point of time of 14:33:55.

Therefore, the lighting control unit 1 sets 750 lx of T_LM as the target value (T_2) of the brightness measured by the second illuminance sensor L2 at the point of time of 14:33:55. The lighting control unit 1 controls the light output of the first lighting device D1 such that the brightness measured by the second illuminance sensor L2 falls within the allowable fluctuation amount (F_T) with reference to the target value (T_LM) of 750 lx.

Next, as shown in FIG. 12A, the lighting control unit 1 acquires information, from the storage element 1-2, that the brightness (P_1) measured by the first illuminance sensor L1 is 43,500 lx, 45,400 lx, 4,700 lx, 47,600 lx, and 48,000 lx, respectively, at each time one second elapses from 14:33:55 to 14:33:59.

The lighting control unit 1 sets, as the standard value P_std1 of the brightness 1, 46,300 lx which is an average value of the brightness for 5 seconds at the point of time of 14:34.

Therefore, the lighting control unit 1 sets 850 lx of T_LH as the target value (T_2) of the brightness measured by the second illuminance sensor L2 at the point of time of 14:34. The lighting control unit 1 controls the light output of the first lighting device D1 such that the brightness measured by the second illuminance sensor L2 falls within the allowable fluctuation amount (F_T) with reference to the target value (T_LH) of 850 lx.

As shown in FIG. 12B, the light output (P_D1) emitted from the first lighting device D1 decreases in proportion to time as the target value (T_2) of the brightness is changed, and the decrease in P_D1 is stopped when the brightness measured by the second illuminance sensor L2 reaches within the allowable fluctuation amount (F_T) with reference to the target value (T_LH).

Next, as shown in FIG. 12A, the lighting control unit 1 acquires information, from the storage element 1-2, that the brightness (P_1) measured by the first illuminance sensor L1 is 45,410 lx, 42,030 lx, 38,760 lx, 34,160 lx, 31,275 lx, 22,500 lx, 31,125 lx, 33,040 lx, 34,850 lx, and 37,710 lx, respectively, at each time one second elapses from 14:36:15 to 14:36:24.

The lighting control unit 1 sets, as the standard value P_std1 of the brightness 1, 38,327 lx which is an average value of the brightness for 5 seconds from 14:36:15 to 14:36:19 at the point of time of 14:36:20.

The lighting control unit 1 changes the target value (T_2) of the brightness measured by the second illuminance sensor L2 to 750 lx of T_LM as P_1 decreases, as shown in FIG. 12B. The lighting control unit 1 controls the light output of the first lighting device D1 such that the brightness measured by the second illuminance sensor L2 falls within the allowable fluctuation amount (F_T) with reference to the target value (T_LM) of 750 lx.

Subsequently, the lighting control unit 1 sets, as the standard value P_std1 of the brightness P_1, 31,845 lx which is an average value of the brightness for 5 seconds from 14:36:20 to 14:36:24 at the point of time of 14:36:25. The standard value P_std1 of the brightness 1 falls within a range of 24,800 lx or more and less than 39,200 lx. Therefore, the lighting control unit 1 does not change the target value (T_2) of the brightness measured by the second illuminance sensor L2 as 750 lx of T_LM.

In the present embodiment, the standard value P_std1 of the brightness P_1 is set based on the average value of the brightness P_1 for five seconds. In a case where the standard value P_std1 of P_1 and the target value of brightness P_2 are set each time based on the measured value of brightness P_1 for every second, the brightness at the point of time of 14:36:20 is 22,500 lx. Therefore, the target value of the brightness P_2 is changed from 850 lx of T_LH to 650 lx of T_LL. However, according to the present embodiment, the standard value P_std1 of brightness P_1 is set based on the average value of the brightness P_1 for five seconds, and thus it is possible to reduce the amount of fluctuation in the target value of the brightness P_2.

Next, as shown in FIG. 12A, the lighting control unit 1 acquires information, from the storage element 1-2, that the brightness (P_1) measured by the first illuminance sensor L1 is 43,000 lx, 40,800 lx, 36,500 lx, 28,100 lx, 21,500 lx, 20,600 lx, 20,500 lx, 20,400 lx, 20,400 lx, and 20,300 lx, respectively, at each time one second elapses from 14:37:35 to 14:37:44.

The lighting control unit 1 sets, as the standard value P_std1 of the brightness 1, 33,980 lx which is an average value of the brightness for 5 seconds from 14:37:35 to 14:37:39 at the point of time of 14:37:40.

The lighting control unit 1 changes the target value (T_2) of the brightness measured by the second illuminance sensor L2 to 750 lx of T_LM at the point of time of 14:37:40 as P_1 decreases, as shown in FIG. 12B. The lighting control unit 1 controls the light output of the first lighting device D1 such that the brightness measured by the second illuminance sensor L2 falls within the allowable fluctuation amount (F_T) with reference to the target value (T_LM) of 750 lx.

Subsequently, the lighting control unit 1 sets, as the standard value P_std1 of the brightness 1, 20,440 lx which is an average value of the brightness for 5 seconds from 14:37:40 to 14:37:44 at the point of time of 14:37:45. The lighting control unit 1 changes the target value (T_2) of the brightness measured by the second illuminance sensor L2 to 650 lx of T_LL at the point of time of 14:37:45 as P_1 decreases, as shown in FIG. 12B. The lighting control unit 1 controls the light output of the first lighting device D1 such that the brightness measured by the second illuminance sensor L2 falls within the allowable fluctuation amount (F_T) with reference to the target value (T_LL) of 650 lx.

As described above, the lighting control unit 1 classifies the brightness (P_1) measured by the first illuminance sensor L1 into three levels and changes the target value of the brightness of the second illuminance sensor L2 in three levels according to the value of P_1.

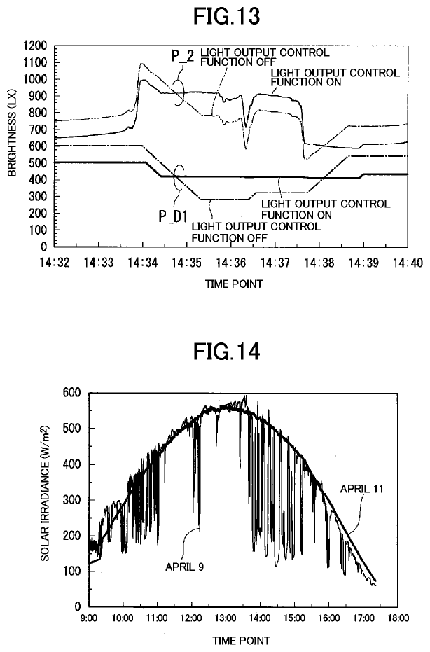

For comparison, in the related art, that is, in the lighting control system S, an operation in a case where the light output control function is off, and the lighting control unit 1 does not change the target value of the brightness measured by the second illuminance sensor L2 according to the brightness measured by the first illuminance sensor L1 will be described. FIG. 13 shows temporal changes of the measured value of the brightness (P_2) by the second illuminance sensor L2 and the light output (P_D1) emitted from the first lighting device D1 in a case where the light output control function is on and in a case where the light output control function is off in the lighting control system S. It is assumed that the operating conditions are the same as those in the second embodiment except that the light output control function is off.

In FIG. 13, the horizontal axis represents time, the vertical axis represents brightness, and the unit is lx. From FIG. 13, as in the present embodiment, it can be seen that the lighting control unit 1 changes the target value of the brightness measured by the second illuminance sensor L2 according to the brightness measured by the first illuminance sensor L1 and thus it is possible to suppress amounts of fluctuation in the measured value of the brightness (P_2) by the second illuminance sensor L2 and the light output (P_D1) emitted from the first lighting device D1.

As described above, in a case where the brightness measured by the first illuminance sensor L1 is higher than predetermined brightness, the lighting control unit 1 changes the target value of the brightness measured by the second illuminance sensor L2 to a high value.

Accordingly, as shown in FIG. 13, the difference between the current brightness and the target value is smaller than in the case where the target value of the brightness measured by the second illuminance sensor L2 is constant. It is possible to shorten the time relating to the control of the brightness.

In a case where the brightness measured by the first illuminance sensor L1 is lower than the predetermined brightness, the lighting control unit 1 changes the target value of the brightness measured by the second illuminance sensor L2 to a low value.

Accordingly, as shown in FIG. 7B, a difference between the current brightness and the target value becomes small as compared with the case where the target value of the brightness measured by the second illuminance sensor L2 is constant. Therefore, it is possible to shorten a time relating to the control of the brightness.

As shown in FIG. 12B, the lighting control unit 1 changes the target value of the brightness measured by the second illuminance sensor L2 according to the brightness measured by the first illuminance sensor L1 and thus the fluctuation of the brightness is reduced. Therefore, it is possible to reduce the discomfort felt by a person who performs the visual work in the work environment E.

According to one aspect of the present invention, as shown in FIG. 13, in a case where the brightness is increased in the work environment E, it is possible to darken the brightness before the brightening as compared with the case where the target value of the brightness P_2 is constant. Therefore, it is possible to control the brightness without damaging the comfort of the visual worker.

According to one aspect of the present invention, in a case where the brightness is reduced in the work environment E, it is possible to brighten the brightness before the dimming as compared with the case where the target value of the brightness P_2 is constant. Therefore, it is possible to control the brightness without damaging the comfort of the visual worker.

### Third Embodiment

Next, a third embodiment of the present invention will be described.

The third embodiment is different from the first and second embodiments in that the first illuminance sensor L1 is the solar irradiance meter installed on the roof or the like, not in the room. The description of the same functions as those of the first and second embodiments will be omitted. In the light control system S according to the present invention, the light is taken into the room using the daylighting device 4. In a case where a window is used as the daylighting device 4, the light from the outside is taken in through the window.

The brightness of the light taken in from the outside has a high correlation with the solar irradiance.

In the present embodiment, the solar irradiance meter is used as the first illuminance sensor L1 (not shown). As described in the first embodiment, the lighting control unit 1 and the solar irradiance meter are connected using the signal line 3 of the wired communication medium, and signals are transmitted and received by a wired communication interface such as Ethernet (registered trademark). Alternatively, the lighting control unit 1 and the solar irradiance meter may be connected, without using the signal line 3, using the wireless communication interface such as Wi-Fi (registered trademark), ZigBee (registered trademark), or the mobile phone network.

In the present embodiment, the light output control information may be assumed to include parameters of a maximum value (So_max) of the solar irradiance (So) and a minimum value (So_min) of the solar irradiance, and So_max and So_min may be set based on a log when the solar irradiance is measured in the past or the like, for example. The other parameters included in the light output control information are assumed to be the same as those in the first embodiment.

FIG. 14 shows an example of a temporal change in a measurement result when the solar irradiance meter continuously measures the solar irradiance during the daytime. The horizontal axis represents time, the vertical axis represents solar irradiance, and the unit is watt/square meter (W/m²).

For example, it is assumed that the light control system S is operated on April 10 of a certain year. It is assumed that the temporal changes in the solar irradiance measured by the solar irradiance meter at the same place on April 9 and April 11 of the previous year thereof are shown in FIG. 14.

As shown in FIG. 14, it can be seen that the maximum and minimum values of the solar irradiance during the daytime at around 14:10 of the same period of the previous year are approximately 550 watts/square meter and 140 watts/square meter from the measurement results of the solar irradiance on two different days of the same period of the previous year.

It is assumed that the values of 550 watts/square meter and 140 watts/square meter are respectively input to the setting device 2 as So_max and So_min when the light control system S is operated.

In this case, the lighting control unit 1 calculates that the calculation result of So_max−(So_max−So_min)×α_P is 345 watts/square meter. The lighting control unit 1 sets 850 lx as the value of the target value 1 (T_LH) in a case where the solar irradiance (So) measured by the solar irradiance meter is equal to or larger than 345 watts/square meter. The lighting control unit 1 sets 650 lx as the value of the target value 2 (T_LL) in a case where the solar irradiance (So) measured by the first illuminance sensor L1 is less than 345 watts/square meter.

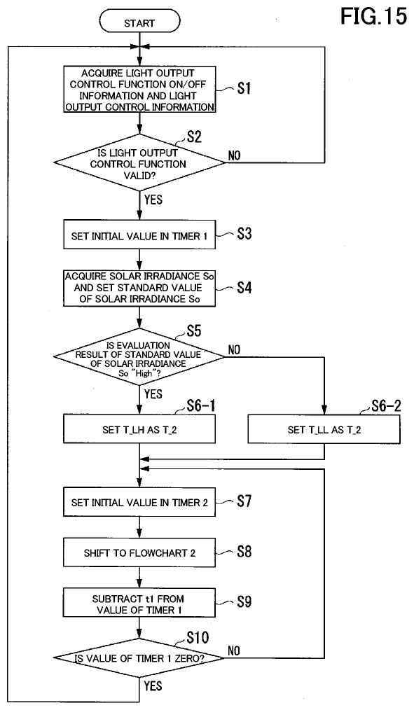

In the present embodiment, the operation sequence of the light control system S will be described. FIG. 15 is a flowchart 1 showing a state transition of the lighting control unit 1 when the light control system S according to the present embodiment operates.

In the present embodiment, the operations in steps S4 and 5 are different from those in the first embodiment. The description of the same functions as those in the first embodiment will be omitted.

<Step S4>

The lighting control unit 1 acquires the solar irradiance (So) acquired from the solar irradiance meter as information representing the brightness. The lighting control unit 1 reads values of the solar irradiance So for the past one cycle from the storage element 1-2 and sets a standard value (So_std) of the brightness P_1 based on the solar irradiance based on the values. For example, the standard value (So_std) of the brightness P_1 based on the solar irradiance may be the number average of the measured values of the solar irradiance So for the past one cycle.

The values of the solar irradiance So for the past one cycle are, for example, measured values of the solar irradiance So corresponding to values until (timer 1, timer 2) changes from a state of (t_con1, t_con2) to (0, 0), and are read from the storage element 1-2 by the lighting control unit 1. In this case, there are (t_con1÷t1)×(t_con2÷t2) times of the measured values of the solar irradiance So. The standard value So_std of the brightness solar irradiance So may be set based on the number average of the measured values or may be set based on the minimum value and the maximum value of the measured values.

In a case where the values of the solar irradiance So for the past one cycle are not stored in the storage element 1-2 or the like, current solar irradiance So may be set as the standard value (So_std) as necessary. Thereafter, the state of the lighting control unit 1 shifts to step S5.

<Step S5>

The lighting control unit 1 evaluates the standard value (So_std) of the brightness based on the solar irradiance acquired from the solar irradiance meter and sets the target value (T_2) of the brightness measured by the second illuminance sensor L2 based on the result.

The evaluation of the standard value So_std performed by the lighting control unit 1 is specifically to determine whether So_std is equal to or larger than So_max−(So_max−So_min)×α_P or So_std is less than So_max−(So_max−So_min)×α_P. The lighting control unit 1 may evaluate the standard value (So_std) of the brightness P_1 based on the solar irradiance, based on any one of So_max or So_min or both So_max or So_min.

In a case where So_std is equal to or larger than So_max−(So_max−So_min)×α_P, the lighting control unit 1 determines that the solar irradiance So_std is “High”. In this case, the state of the lighting control unit 1 shifts to step S6-1.

In a case where So_std is less than So_max−(So_max−So_min)×α_P, the lighting control unit 1 determines that the solar irradiance So_std is not “High”. In this case, the state of the lighting control unit 1 shifts to step S6-2.

<Step S7>

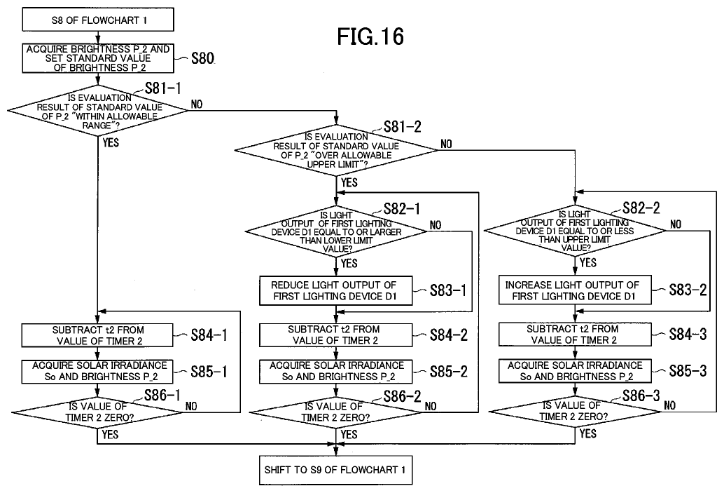

In step S7, the operation when the lighting control unit 1 controls the intensity of the light emitted from the light sources D1-3 based on the light output control information will be described based on the flowchart 2. FIG. 16 shows a flowchart 1 in the present embodiment. In the first embodiment, the operations described with reference to FIG. 4 are the same as the operations other than the operations of steps S80, S85-1, S85-2, and S85-3. Therefore, the description thereof will be omitted.

<Step S80>

The lighting control unit 1 acquires the brightness P_2 and sets the brightness as the standard value (P_std) of P_2. Thereafter, the lighting control unit 1 shifts to step S81-1.

<Steps S85-1, S85-2, and S85-3>

The lighting control unit 1 acquires the solar irradiance So and the brightness P_2, and stores the values of So and P_2 in the storage element 1-2, respectively, as the solar irradiance and the brightness corresponding to the value of the timer 2 at the point of time. Thereafter, the lighting control unit 1 shifts from step S85-1 to step S86-1, from step S85-2 to step S86-2, and from step S85-3 to step S86-3, respectively.

Next, the operation of the light control system S when So_max and So_min are set as described above will be described in detail.

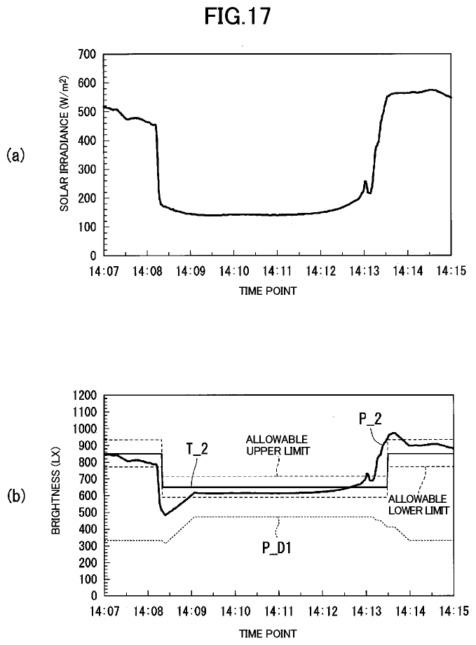

FIG. 17A shows a temporal change in the solar irradiance measured by the first illuminance sensor L1 from 14:07 to 14:15.

FIG. 17B shows temporal changes of the target value (T_2) of the brightness measured by the second illuminance sensor L2, the measured value of the brightness (P_2) by the second illuminance sensor L2, and the light output (P_D1) emitted from the first lighting device D1 in the same time zone.

In FIG. 17A, the horizontal axis is time, the vertical axis is the solar irradiance, and the unit is watt/square meter (W/m²).

In FIG. 17B, the horizontal axis is time, the vertical axis is brightness, and the unit is lx.

As shown in FIG. 17A, the lighting control unit 1 acquires information, from the storage element 1-2, that the solar irradiance measured by the solar irradiance meter is 499, 498, 498, 497, 497, 497, 496, 495, 495, and 493 watts/square meter, respectively, at each time one second elapses from 14:07 to 14:07:09.

The lighting control unit 1 calculates that the average value of the solar irradiance during the period is 496.5 watts/square meter and sets the value as So_std.

Therefore, the lighting control unit 1 sets 850 lx of T_LH as the target value (T_2) of the brightness measured by the second illuminance sensor L2 at the point of time of 14:07:10. The lighting control unit 1 controls the light output of the first lighting device D1 such that the brightness measured by the second illuminance sensor L2 falls within the allowable fluctuation amount (F_T) with reference to the target value (T_LH) of 850 lx.

Next, as shown in FIG. 17A, the lighting control unit 1 acquires information, from the solar irradiance meter, that the solar irradiance (So) measured by the solar irradiance meter is 445, 443, 437, 419, 384, 296, 242, 218, 191, 180 watts/square meter, respectively, at each time one second elapses from 14:08 to 14:08:09.

The lighting control unit 1 calculates that the average value of the solar irradiance in the period is 325.5 watts/square meter and sets the value as So_std at the point of time of 14:08:10. The lighting control unit 1 changes the target value (T_2) of the brightness measured by the second illuminance sensor L2 to 650 lx of T_LL as So decreases, as shown in FIG. 17B. The lighting control unit 1 controls the light output of the first lighting device D1 such that the brightness measured by the second illuminance sensor L2 falls within the allowable fluctuation amount (F_T) with reference to the target value (T_LL) of 650 lx.

As shown in FIG. 17B, the light output (P_D1) emitted from the first lighting device D1 increases in proportion to time as the target value (T_2) of the brightness is changed, and the increase in P_D1 is stopped when the dimming time (t_con2) elapses. The brightness control for the first lighting device D1 may be stopped when the brightness measured by the second illuminance sensor L2 reaches within the allowable fluctuation amount based on the target value (T_LL) without necessarily waiting for the dimming time (t_2) to elapse.

Next, as shown in FIG. 17A, the lighting control unit 1 acquires information, from the storage element 1-2, that the solar irradiance (So) measured by the solar irradiance meter is 184.6, 194.6, 214.6, 244.6, 325.55, 414.45, 490, 500, 505, and 508 watts/square meter, respectively, at each time one second elapses from 14:13 to 14:13:09.

The lighting control unit 1 calculates that the average value of the solar irradiance in the period is 358.1 watts/square meter and sets the value as So_std at the point of time of 14:13:10.

The lighting control unit 1 changes the target value (T_2) of the brightness measured by the second illuminance sensor L2 to 850 lx of T_LH as the solar irradiance (So) increases, as shown in FIG. 17B. The lighting control unit 1 controls the light output of the first lighting device D1 such that the brightness measured by the second illuminance sensor L2 falls within the allowable fluctuation amount around the target value (T_LH) of 850 lx.

As shown in FIG. 17B, the light output (P_D1) emitted from the first lighting device D1 decreases in proportion to time as the target value (T_2) of the brightness is changed, and the decrease in P_D1 is stopped when the brightness measured by the second illuminance sensor L2 reaches within the allowable fluctuation amount based on the target value (T_LH) and the dimming time (t_con2) elapses. The brightness control for the first lighting device D1 may be stopped when the brightness measured by the second illuminance sensor L2 reaches within the allowable fluctuation amount based on the target value (T_LL) without necessarily waiting for the dimming time (t_2) to elapse.

As described above, in a case where the solar irradiance measured by the solar irradiance meter is larger than a predetermined solar irradiance, the lighting control unit 1 changes the target value of the brightness measured by the second illuminance sensor L2 to a high value.

Accordingly, the difference between the current brightness and the target value is smaller than in the case where the target value of the brightness measured by the second illuminance sensor L2 is constant. It is possible to shorten the time relating to the control of the brightness. It is possible to increase the minimum value when the light output is reduced. Therefore, it is possible to suppress the amount of fluctuation in brightness when the light control is performed.

In a case where the solar irradiance measured by the solar irradiance meter is less than the predetermined solar irradiance, the lighting control unit 1 changes the target value of the brightness measured by the second illuminance sensor L2 to a low value.

Accordingly, the difference between the current brightness and the target value is smaller than in the case where the target value of the brightness measured by the second illuminance sensor L2 is constant. It is possible to shorten the time relating to the control of the brightness. It is possible to reduce the maximum value when the light output is increased and increase the minimum value when the light output is reduced. Therefore, it is possible to suppress the amount of fluctuation in brightness when the light control is performed.

### Summary of Third Embodiment

In the light control system S according to the present embodiment, the solar irradiance is measured by using the solar irradiance meter installed on the roof or the like. The lighting control unit 1 acquires information representing the brightness during the daytime based on the measurement result of the solar irradiance acquired from the solar irradiance meter. The lighting control unit 1 changes the target value of the brightness measured by the second illuminance sensor L2 based on the information representing the brightness. The lighting control unit 1 controls the light output emitted from the first lighting device D1 such that the brightness measured by the second illuminance sensor falls within the allowable fluctuation amount with reference to the target value.

As shown in FIG. 17B, the lighting control unit 1 changes the target value of the brightness measured by the second illuminance sensor L2 according to the brightness measured by the first illuminance sensor L1 and thus the fluctuation of the brightness is reduced. Therefore, it is possible to reduce the discomfort felt by a person who performs the visual work in the work environment E.

According to one aspect of the present invention, in a case where the brightness is reduced in the work environment E, it is possible to brighten the brightness before the dimming as compared with the case where the target value of the brightness P_2 is constant. Therefore, it is possible to control the brightness without damaging the comfort of the visual worker.

According to one aspect of the present invention, in a case where the brightness is increased in the work environment E, it is possible to darken the brightness before the brightening as compared with the case where the target value of the brightness P_2 is constant. Therefore, it is possible to control the brightness without damaging the comfort of the visual worker.

### Fourth Embodiment

Next, a fourth embodiment of the present invention will be described.

The fourth embodiment is characterized in that the target value (T_2) of the brightness of the second illuminance sensor L2 is changed based on the brightness measured by the second illuminance sensor L2. The second illuminance sensor L2 is installed on the upper side of the work environment E, and the brightness measured by the second illuminance sensor L2 includes the brightness of a desk top surface, a floor surface, or a wall surface. Alternatively, the second illuminance sensor L2 may be installed on the ceiling and measure the brightness of the desk top surface from the ceiling. The description of the same functions as those of the first to third embodiments will be omitted.

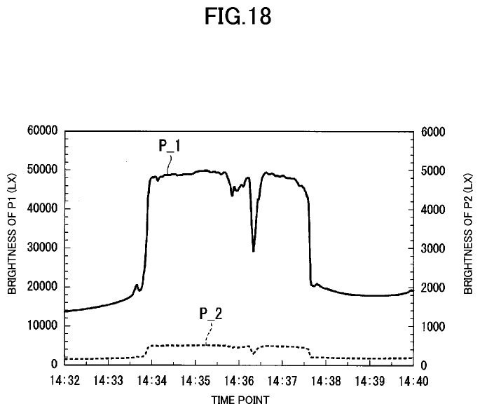

FIG. 18 shows an example of temporal changes in the measured value of the brightness (P_1) by the first illuminance sensor L1 and the measured value of the brightness (P_2) by the second illuminance sensor L2. The horizontal axis is time.

In FIG. 18, the left vertical axis represents the brightness of P_1 and the right vertical axis represents the brightness of P_2.

As shown in FIG. 18, it can be seen that there is a high correlation between P_1 and P_2 and in this example, the value of P_2 is about 1/100 of the value of P_1. The lighting control unit 1 may change the target value (T_2) of the brightness of the second illuminance sensor L2 based on the brightness (P_2) measured by the second illuminance sensor L2.

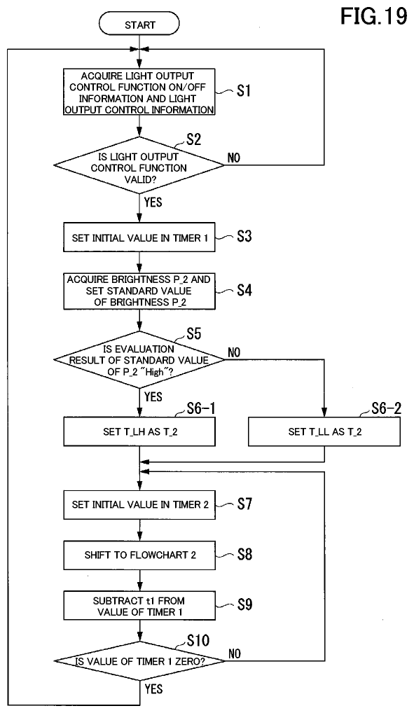

Next, an operation sequence of the light control system S according to the present embodiment will be described. FIG. 19 is a flowchart 1 showing a state transition of the lighting control unit 1 according to the present embodiment.

A difference from the first embodiment is that the target value (T_2) of the brightness of the second illuminance sensor L2 is changed based on the brightness measured by the second illuminance sensor L2 in steps S4 and S5.

<Step S4>

The lighting control unit 1 acquires the brightness (P_2) from the second illuminance sensor L2 and sets the brightness as the standard value (P_std2) of P_2. Alternatively, the lighting control unit 1 may read values of the brightness P_2 for the past one cycle from the storage element 1-2 and set a standard value (P_std2) of the brightness P_2 based on the values of the brightness P_2. For example, the standard value (P_std2) of the brightness P_2 may be a number average of the measured values of the brightness P_2 for the past one cycle. Thereafter, the state of the lighting control unit 1 shifts to step S5.

<Step S5>

The lighting control unit 1 evaluates the standard value P_std2 of the set brightness P_2 and sets the target value (T_2) of the brightness measured by the second illuminance sensor L2 based on the result.

The evaluation of the standard value P_std2 of the brightness (P_2) performed by the lighting control unit 2 is specifically to determine whether P_std2 is equal to or larger than P_max−(P_max−P_min)×α_P or P_std2 is less than P_max−(P_max−P_min)×α_P.

In a case where P_std2 is equal to or larger than P_max−(P_max−P_min)×α_P, the lighting control unit 1 determines that the brightness P_2 is “High”. In this case, the state of the lighting control unit 1 shifts to step S6-1.

In a case where P_std2 is less than P_max−(P_max−P_min)×α_P, the lighting control unit 1 determines that the brightness P_2 is not “High”. In this case, the state of the lighting control unit 1 shifts to step S6-2.

The operation of controlling the light output (P_D1) emitted from the first lighting device D1 based on the flowchart 2 in step S8 is the same as that in the first embodiment, and thus the description thereof is omitted.

As described above, in a case where the brightness measured by the second illuminance sensor L2 is higher than the predetermined brightness, the lighting control unit 1 changes the target value of the brightness measured by the second illuminance sensor L2 to a high value.

Accordingly, the difference between the current brightness and the target value is smaller than in the case where the target value of the brightness measured by the second illuminance sensor L2 is constant. It is possible to shorten the time relating to the control of the brightness.

In a case where the brightness measured by the second illuminance sensor L2 is lower than the predetermined brightness, the lighting control unit 1 changes the target value of the brightness measured by the second illuminance sensor L2 to a low value.

Accordingly, the difference between the current brightness and the target value is smaller than in the case where the target value of the brightness measured by the second illuminance sensor L2 is constant. It is possible to shorten the time relating to the control of the brightness.

It is possible to reduce the maximum value when the light output is increased and increase the minimum value when the light output is reduced. Therefore, it is possible to suppress the amount of fluctuation in brightness when the light control is performed.

### Summary of Fourth Embodiment

In the light control system S according to the present embodiment, the lighting control unit 1 acquires the brightness measured by the second illuminance sensor L2. The second illuminance sensor L2 includes an illuminance sensor L2-3 and measures the brightness of the desk top surface, the floor surface, or the wall surface. The lighting control unit 1 changes the target value of the brightness measured by the second illuminance sensor L2 based on the brightness information representing the brightness of the desk top surface, the floor surface, or the wall surface acquired from the second illuminance sensor L2. The lighting control unit 1 controls the light output emitted from the first lighting device D1 such that the brightness measured by the second illuminance sensor falls within the allowable fluctuation amount with reference to the target value.

In this manner, the lighting control unit 1 changes the target value of the brightness measured by the second illuminance sensor L2 according to the brightness measured by the second illuminance sensor L2 and thus the fluctuation of the brightness is reduced as in the first, second, and third embodiments. Therefore, it is possible to reduce the discomfort felt by a person who performs the visual work in the work environment E.

According to one aspect of the present invention, in a case where the brightness is reduced in the work environment E, it is possible to brighten the brightness before the dimming as compared with the case where the target value of the brightness P_2 is constant. Therefore, it is possible to control the brightness without damaging the comfort of the visual worker.

According to one aspect of the present invention, in a case where the brightness is increased in the work environment E, it is possible to darken the brightness before the brightening as compared with the case where the target value of the brightness P_2 is constant. Therefore, it is possible to control the brightness without damaging the comfort of the visual worker.

### Fifth Embodiment

Next, a fifth embodiment of the present invention will be described.

In the fifth embodiment, unlike the first, second, third, and fourth embodiments, a means that determines the brightness of light taken into the room by using the daylighting device 4 is information on a sky image or a cloud amount by an imaging element such as a camera installed near the window or on the roof. The description of the same functions as those of the first to fourth embodiments will be omitted.

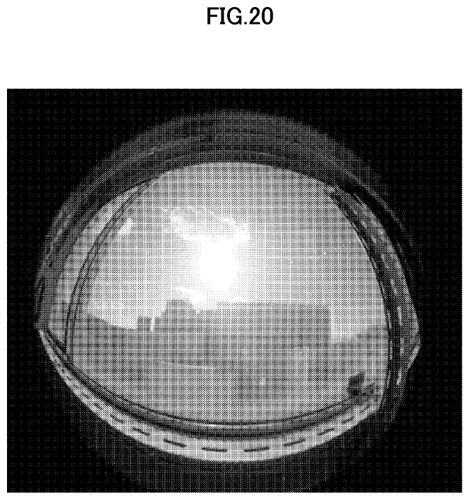

FIG. 20 shows an example of a sky image captured inside the room with a light reception unit of the camera installed in the vertical direction and directed outside the window. As shown in FIG. 20, a part of the sky is covered with clouds, and the lighting control unit 1 can determine whether or not the sun is hidden by the clouds by acquiring the captured image. The lighting control unit 1 can determine the cloud amount by acquiring the captured image. When the cloud amount is large, the solar irradiance decreases. Therefore, the brightness taken into the room depends on the cloud amount. Therefore, the lighting control unit 1 can use the sky image or the cloud amount acquired from the camera as information representing the brightness.

In the present embodiment, it is assumed that the camera is installed near the window or on the roof, for example. The camera captures an image of the sky. The camera is connected to the lighting control unit 1 and the like using the signal line 3 of the wired communication medium (not shown) as described in the first embodiment. The signals may be transmitted and received between the lighting control unit 1 and the camera by the wired communication interface such as Ethernet (registered trademark). Alternatively, the lighting control unit 1 and the solar irradiance meter may transmit and receive, without using the signal line 3, using the wireless communication interface such as Wi-Fi (registered trademark), ZigBee (registered trademark), or the mobile phone network.

The lighting control unit 1 acquires an image from the camera through the signal line 3. The lighting control unit 1 may evaluate a current ratio (R_C) of an area of a cloud portion (Sec_C) to an area of a sky portion (Sec_S) in the image to estimate current brightness.

Other parameters for the light output control information are assumed to be the same as those in the first embodiment.

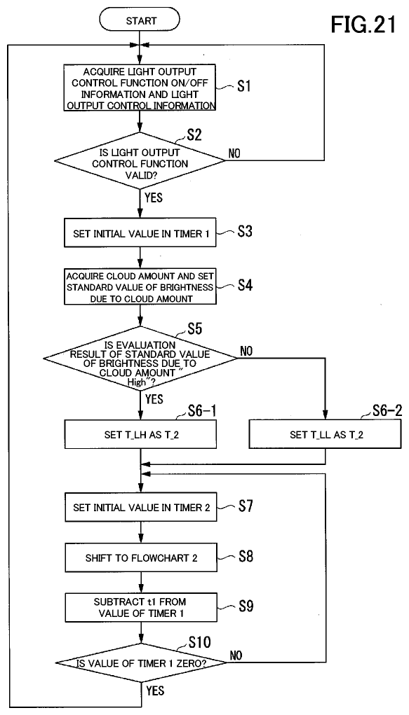

In the present embodiment, the operation sequence of the light control system S will be described. FIG. 21 is a flowchart 1 showing a state transition of the lighting control unit 1 when the light control system S according to the present embodiment operates.

In the present embodiment, operations in steps S4 and S5 are different from those in the first, third, and fourth embodiments. The description of the same functions as those of the first, third, and fourth embodiments will be omitted.

<Step S4>

The lighting control unit 1 acquires the cloud amount from the camera. The lighting control unit 1 reads cloud amount values for the past one cycle from the storage element 1-2 and sets a standard value (Rc_std) of the brightness due to the cloud amount based on the values. For example, the standard value (Rc_std) of the brightness due to the cloud amount may be the number average of the measured values of the cloud amount for the past one cycle. Thereafter, the lighting control unit 1 shifts to step S5.

The values of the cloud amount for the past one cycle are, for example, measured values of the cloud amount corresponding to values until (timer 1, timer 2) changes from a state of (t_con1, t_con2) to (0, 0), and are read from the storage element 1-2 by the lighting control unit 1. In this case, there are (t_con1÷t1)×(t_con2÷t2) times of the measured values of the cloud amount. The standard value (Rc_std) of the brightness due to the cloud amount may be set based on the number average of the measured values or may be set based on the minimum value and the maximum value of the measured values.

In a case where the values of the cloud amount for the past one cycle are not stored in the storage element 1-2 or the like, a current cloud amount may be set as the standard value (Rc_std) as necessary. Thereafter, the state of the lighting control unit 1 shifts to step S5.

<Step S5>

The lighting control unit 1 evaluates the standard value (Rc_std) of the brightness by the acquired cloud amount and sets the target value (T_2) of the brightness measured by the second illuminance sensor L2 based on the result.

The evaluation of the brightness due to the cloud amount performed by the lighting control unit 1 is specifically to evaluate whether (1−Rc_std) is equal to or larger than α_P or (1−Rc_std) is less than α_P. That is, the evaluation thereof is to estimate a ratio of a region in the sky not blocked by the cloud.

In a case where (1−Rc_std) is equal to or larger than α_P, the lighting control unit 1 determines that the evaluation result of the brightness due to the cloud amount is “High”. In this case, the state of the lighting control unit 1 shifts to step S6-1.

In a case where (1−Rc_std) is less than α_P, the lighting control unit 1 determines that the evaluation result of the brightness due to the cloud amount is not “High”. In this case, the state of the lighting control unit 1 shifts to step S6-2.

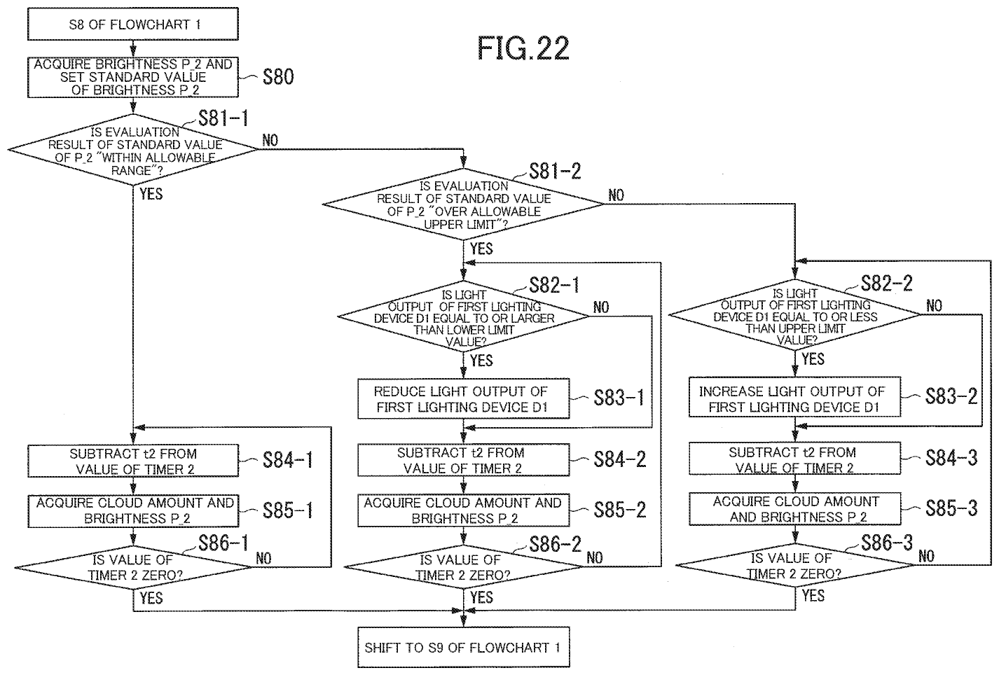

In step S7, the operation when the lighting control unit 1 controls the intensity of the light emitted from the light source D1-3 based on the light output control information will be described based on the flowchart 2 in the present embodiment shown in FIG. 22. In the first embodiment, the operations described with reference to FIG. 4 are the same as the operations other than the operations of steps S80, S85-1, S85-2, and S85-3. Therefore, the description thereof will be omitted.

<Step S80>

The lighting control unit 1 acquires the brightness P_2 and sets the brightness as the standard value (P_std) of P_2. Thereafter, the lighting control unit 1 shifts to step S81-1.

<Steps S85-1, S85-2, and S85-3>

The lighting control unit 1 acquires the cloud amount and the brightness P_2, and stores the cloud amount and the value of P_2 in the storage element 1-2, respectively, as the cloud amount and the brightness corresponding to the value of the timer 2 at the point of time. Thereafter, the lighting control unit 1 shifts from step S85-1 to step S86-1, from step S85-2 to step S86-2, and from step S85-3 to step S86-3, respectively.

Next, the operation of the light control system S in the present embodiment will be described in detail.

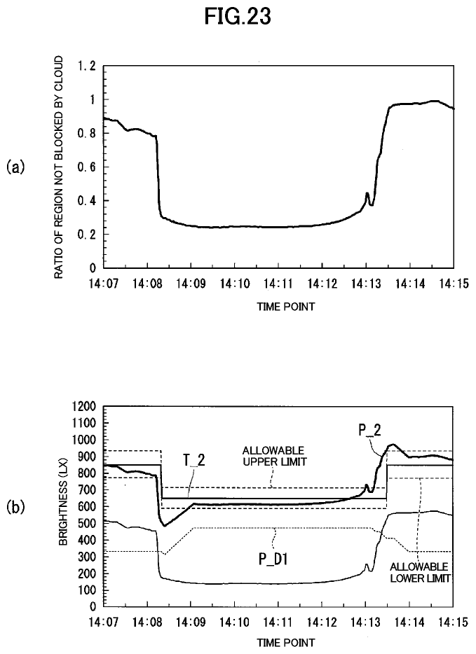

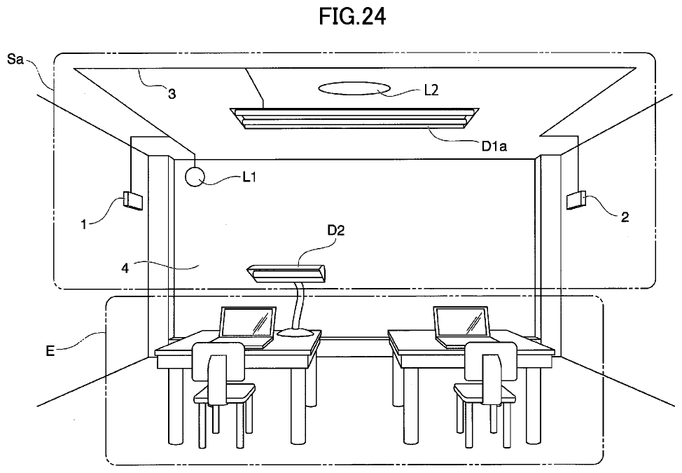

FIG. 23A shows a temporal change in (1−R_C) of the region in the sky area not blocked by the cloud from 14:07 to 14:15.

FIG. 23B shows temporal changes of the target value (T_2) of the brightness measured by the second illuminance sensor L2, the measured value of the brightness (P_2) by the second illuminance sensor L2, and the light output (P_D1) emitted from the first lighting device D1 in the same time zone.

In FIG. 23A, the horizontal axis is time, and the vertical axis is a ratio (1−R_C) of the cloud amount to the sky area.

In FIG. 23B, the horizontal axis is time, the vertical axis is brightness, and the unit is lx.

As shown in FIG. 23A, the lighting control unit 1 acquires information, from the storage element 1-2, that the ratio (1−R_C) of the area of the cloud amount to a sky region, which is acquired by the lighting control unit 1 from the camera, is 0.89, 0.89, 0.89, 0.89, 0.89, 0.89, 0.89, 0.89, 0.89, and 0.88, respectively, at each time one second elapses from 14:07 to 14:07:09.

The lighting control unit 1 sets 0.89, which is the average value of the period, as the standard value Rc_std of the ratio (1−R_C) of the area of the cloud amount to the sky region in the period.

Therefore, the lighting control unit 1 sets 850 lx of T_LH as the target value (T_2) of the brightness measured by the second illuminance sensor L2 at the point of time of 14:07:10. The lighting control unit 1 controls the light output of the first lighting device D1 such that the brightness measured by the second illuminance sensor L2 falls within the allowable fluctuation amount (F_T) with reference to the target value (T_LH) of 850 lx.

Next, as shown in FIG. 23A, the lighting control unit 1 acquires information, from the storage element 1-2, that the ratio (1−R_C) based on the cloud amount acquired by the lighting control unit 1 from the camera is 0.78, 0.75, 0.69, 0.53, 0.43, 0.39, 0.34, 0.32, 0.32, and 0.31, respectively, at each time one second elapses from 14:08 to 14:08:09.

The lighting control unit 1 sets 0.49, which is the average value of the period, as the standard value Rc_std of the ratio (1−R_C) of the area of the cloud amount to the sky region in the period at the point of time of 14:07:10.

The lighting control unit 1 changes the target value (T_2) of the brightness measured by the second illuminance sensor L2 to 650 lx of T_LL as (1−R_C) decreases, as shown in FIG. 23B. The lighting control unit 1 controls the light output of the first lighting device D1 such that the brightness measured by the second illuminance sensor L2 falls within the allowable fluctuation amount (F_T) with reference to the target value (T_LL) of 650 lx.

As shown in FIG. 23B, the light output (P_D1) emitted from the first lighting device D1 increases in proportion to time as the target value (T_2) of the brightness is changed, and the increase in P_D1 is stopped when the brightness measured by the second illuminance sensor L2 reaches within the allowable fluctuation amount based on the target value (T_LL) and the dimming time (t_con2) elapses. The brightness control for the first lighting device D1 may be stopped when the brightness measured by the second illuminance sensor L2 reaches within the allowable fluctuation amount based on the target value (T_LL) without necessarily waiting for the dimming time (t_2) to elapse.

Next, as shown in FIG. 23A, the lighting control unit 1 acquires information, from the storage element 1-2, that the ratio (1−R_C) based on the cloud amount acquired by the lighting control unit 1 from the camera is 0.30, 0.31, 0.33, 0.35, 0.38, 0.44, 0.58, 0.74, 0.88, and 0.89, respectively, at each time one second elapses from 14:13 to 14:13:09.

The lighting control unit 1 sets 0.52, which is the average value of the period, as the standard value Rc_std of the ratio (1−R_C) of the area of the cloud amount to the sky region in the period at the point of time of 14:13:10.

The lighting control unit 1 changes the target value (T_2) of the brightness measured by the second illuminance sensor L2 to 850 lx of T_LH as (1−R_C) increases, as shown in FIG. 19B. The lighting control unit 1 controls the light output of the first lighting device D1 such that the brightness measured by the second illuminance sensor L2 falls within the allowable fluctuation amount around the target value (T_LH) of 850 lx.

As shown in FIG. 23B, the light output (P_D1) emitted from the first lighting device D1 decreases in proportion to time as the target value (T_2) of the brightness is changed, and the decrease in P_D1 is stopped when the brightness measured by the second illuminance sensor L2 reaches within the allowable fluctuation amount based on the target value (T_LH).

As described above, in a case where the ratio (1−R_C) of the region in the sky not blocked by the cloud, which is obtained based on the cloud region acquired by the lighting control unit 1 from the camera, is higher than a predetermined ratio, the lighting control unit 1 changes the target value of the brightness measured by the second illuminance sensor L2 to a high value.

Accordingly, the difference between the current brightness and the target value is smaller than in the case where the target value of the brightness measured by the second illuminance sensor L2 is constant. It is possible to shorten the time relating to the control of the brightness.

In a case where the ratio (1−R_C) of the region in the sky not blocked by the cloud, which is obtained based on the cloud region acquired from the camera, is less than the predetermined ratio, the lighting control unit 1 changes the target value of the brightness measured by the second illuminance sensor L2 to a low value.

Accordingly, the difference between the current brightness and the target value is smaller than in the case where the target value of the brightness measured by the second illuminance sensor L2 is constant. It is possible to shorten the time relating to the control of the brightness.

It is possible to reduce the maximum value when the light output is increased and increase the minimum value when the light output is reduced. Therefore, it is possible to suppress the amount of fluctuation in brightness when the light control is performed.

### Summary of Fifth Embodiment

In the light control system S according to the present embodiment, the lighting control unit 1 acquires the information representing the sky image or the cloud amount captured by the camera. The lighting control unit 1 evaluates the brightness from the acquired information representing the sky image or the cloud amount according to whether or not the sun is hidden by the cloud, and changes the target value of the brightness measured by the second illuminance sensor L2. The lighting control unit 1 controls the light output emitted from the first lighting device D1 such that the brightness measured by the second illuminance sensor falls within the allowable fluctuation amount with reference to the target value.

In this manner, the lighting control unit 1 changes the target value of the brightness measured by the second illuminance sensor L2 according to the brightness evaluated by the cloud amount acquired from the camera and thus the fluctuation of the brightness is reduced as in the first, second, third, and fourth embodiments. Therefore, it is possible to reduce the discomfort felt by a person who performs the visual work in the work environment E.

According to one aspect of the present invention, in a case where the brightness is reduced in the work environment E, it is possible to brighten the brightness before the dimming as compared with the case where the target value of the brightness P_2 is constant. Therefore, it is possible to control the brightness without damaging the comfort of the visual worker.

According to one aspect of the present invention, in a case where the brightness is increased in the work environment E, it is possible to darken the brightness before the brightening as compared with the case where the target value of the brightness P_2 is constant. Therefore, it is possible to control the brightness without damaging the comfort of the visual worker.

### Sixth Embodiment

Next, a sixth embodiment of the present invention will be described.

FIG. 24 shows an application example of a light control system Sa according to the sixth embodiment of the present invention. The light control system Sa is configured in a room and includes a lighting control unit 1, a first illuminance sensor L1, a second illuminance sensor L2, a first lighting device D1a, a second lighting device D2, a setting device 2, a signal line 3, and a daylighting device 4. In the present embodiment, the description of the same functions as those of the first to fifth embodiments will be omitted.

As shown in FIG. 24, the first lighting device D1a is installed near the ceiling, and the second lighting device D2 is installed in the work environment E. In addition to the configurations of the first to fifth embodiments, the second lighting device D2 is also connected to the lighting control unit 1 and the like through the signal line 3.

In the present embodiment, the first lighting device D1a is ambient lighting that illuminates at least the periphery of the work environment E. The second lighting device D2 is task lighting that illuminates a visual work surface such as at least a desk in the work environment E.

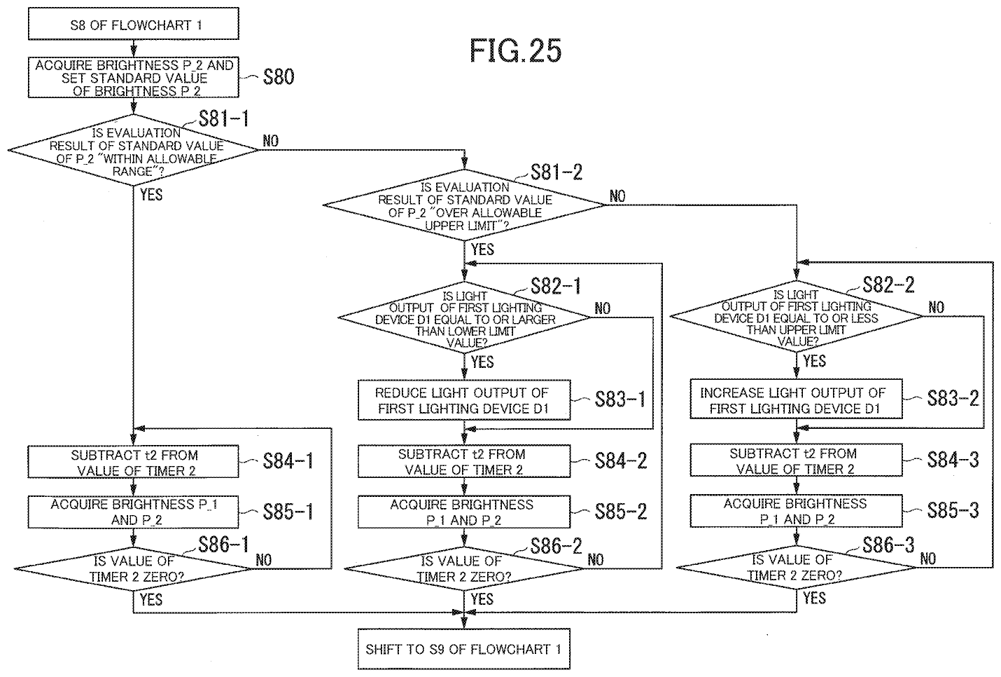

Next, an operation sequence of the light control system Sa according to the present embodiment will be described. The lighting control unit 1 changes the standard value (P_std1) of the brightness P_1 or the target value of the brightness measured by the second illuminance sensor L2 based on the flowchart 1 shown in FIG. 3 as in the first embodiment. FIG. 25 is a flowchart 2 showing a state transition of the lighting control unit 1 when the light control system Sa operates.

In the flowchart 2 of the present embodiment shown in FIG. 25, a difference from the first embodiment is that the lighting control unit 1 controls the light output emitted from the first lighting device D1a in steps S83-1 and S83-2. It is assumed that the same parameters and values as in the first embodiment are used for the light output control information.

It is assumed that the lighting control unit 1 controls the light output emitted from the first lighting device D1a such that the target value (T_2) of the brightness measured by the second illuminance sensor L2 falls within the allowable fluctuation amount (F_T) with reference to the target value (T_2), and as a result, the result as shown in FIG. 6B is obtained.

FIG. 6B shows an example in which the lighting control unit 1 sets the target value T_2 to 650 lx as T_LL and 850 lx as T_LH, but these target values are not limited to the above. However, the lighting control unit 1 may change T_LL to a value of 100 lx or more and T_LH to 500 lx or less, for example.

The lighting control unit 1 may control the light output emitted from the second lighting device D2, not the first lighting device D1a, such that the target value (T_2) of the brightness measured by the second illuminance sensor L2 falls within the allowable fluctuation amount (F_T) with reference to the target value (T_2), or may control the light output emitted from both the first lighting device D1a and the second lighting device D2.

As described above, in a case where the brightness measured by the first illuminance sensor L1 is higher than predetermined brightness, the lighting control unit 1 changes the target value of the brightness measured by the second illuminance sensor L2 to a high value.

Accordingly, the difference between the current brightness and the target value is smaller than in the case where the target value of the brightness measured by the second illuminance sensor L2 is constant. It is possible to shorten the time relating to the control of the brightness.

In a case where the brightness measured by the first illuminance sensor L1 is lower than the predetermined brightness, the lighting control unit 1 changes the target value of the brightness measured by the second illuminance sensor L2 to a low value.

Accordingly, the difference between the current brightness and the target value is smaller than in the case where the target value of the brightness measured by the second illuminance sensor L2 is constant. It is possible to shorten the time relating to the control of the brightness.

It is possible to reduce the maximum value when the light output is increased and increase the minimum value when the light output is reduced. Therefore, it is possible to suppress the amount of fluctuation in brightness when the light control is performed.

### Summary of Sixth Embodiment

The light control system S according to the present embodiment includes the first lighting device D1a and the second lighting device D2, and each of the first lighting device D1a and the second lighting device D2 illuminates the visual work surface and the surroundings. The lighting control unit 1 changes the target value of the brightness measured by the second illuminance sensor L2 based on the information on the brightness acquired from the first illuminance sensor L1. The lighting control unit 1 controls the light output emitted from any one or both of the first lighting device D1a and the second lighting device D2 such that the brightness measured by the second illuminance sensor L2 falls within the allowable fluctuation amount with reference to the target value.

The light control system S according to the present embodiment includes the first lighting device D1a and the second lighting device D2, and each of the first lighting device D1a and the second lighting device D2 illuminates the visual work surface and the surroundings. The lighting control unit 1 changes the target value of the brightness measured by the second illuminance sensor L2 based on the information on the brightness acquired from the first illuminance sensor L1. The lighting control unit 1 controls the light output emitted from the first lighting device D1a such that the brightness measured by the second illuminance sensor L2 falls within the allowable fluctuation amount with reference to the target value.

When the lighting control unit 1 changes the target value, the target value is changed to 100 lx or more as a low value and the target value is changed to 500 lx or less as a high value.

In this manner, the lighting control unit 1 changes the target value of the brightness measured by the second illuminance sensor L2 according to the brightness evaluated by the cloud amount acquired from the camera and thus the fluctuation of the brightness is reduced as in the first, second, third, fourth, and fifth embodiments. Therefore, it is possible to reduce the discomfort felt by a person who performs the visual work in the work environment E.

According to one aspect of the present invention, in a case where the brightness is reduced in the work environment E, it is possible to brighten the brightness before the dimming as compared with the case where the target value of the brightness P_2 is constant. Therefore, it is possible to control the brightness without damaging the comfort of the visual worker.

According to one aspect of the present invention, in a case where the brightness is increased in the work environment E, it is possible to darken the brightness before the brightening as compared with the case where the target value of the brightness P_2 is constant. Therefore, it is possible to control the brightness without damaging the comfort of the visual worker.

### Summary of First to Sixth Embodiments

The light control device according to one aspect of the present invention includes the lighting control unit 1, the first lighting device D1 or D1a, and the second lighting device D2. The lighting control unit 1 changes the light output, that is, the brightness, emitted from at least any one of the first lighting device D1 or D1a or the second lighting device D2 toward the target value.

The light control device according to one aspect of the present invention includes the first illuminance sensor L1, the second illuminance sensor L2, the solar irradiance meter, the camera, and the like. The first illuminance sensor L1, the second illuminance sensor L2, the solar irradiance meter, the camera, and the like acquire the brightness information representing the brightness.

The lighting control unit 1 changes the target value of the brightness based on the brightness information acquired from at least any one of the first illuminance sensor L1, the second illuminance sensor L2, the solar irradiance meter, and the camera.

In each of the above embodiments, the evaluation of the brightness (P_1) performed by the lighting control unit 1 may be performed based on a fixed value. For example, the lighting control unit 1 may evaluate the brightness to be “High” in a case where P_1 is equal to or larger than a threshold value T1 and may evaluate the brightness to be not “High” in a case where P_1 is less than the threshold value T1. There may be a plurality of threshold values of P_1.

In each of the above embodiments, when the maximum brightness value (P_max) and the minimum brightness value (P_min) are set, the values may be set based on a weather forecast or the like, may be set according to a specified period including the same day in the past, and may be set, for example, for each month or week.

In each of the above embodiments, in a case where the light output control function on/off information is set, the information may be set by acquiring the weather forecast of the day or manually by a person in the room.

The preferred embodiments of the present invention have been described above with reference to the accompanying drawings, but it goes without saying that the present invention is not limited to the related examples. It is obvious to those skilled in the art that various change examples or modification examples can be conceived within the scope of the technical idea described in the claims, and of course, it is understood that the examples also belong to the technical scope of the present invention.

1. A light control system comprising:
a daylighting unit that takes in outside light;
a lighting unit that is able to adjust an output of light;
an acquisition unit that acquires brightness information representing brightness, including at least brightness of the outside light taken in from the daylighting unit; and
a control unit that controls the output of light toward a target value,
wherein the control unit changes the target value based on the brightness information.

2. The light control system according to claim 1,
wherein the control unit changes the target value based on brightness information representing the brightness of the outside light.

3. The light control system according to claim 1,
wherein an interval for changing the target value is longer than a time for continuing the control of the output of light in the control unit.

4. The light control system according to claim 1,
wherein the control unit changes the target value to a high value in a case where the brightness indicated by the brightness information is higher than predetermined brightness.

5. The light control system according to claim 1,
wherein the control unit changes the target value to a low value in a case where the brightness indicated by the brightness information is lower than predetermined brightness.

6. The light control system according to claim 1,
wherein the control unit changes the target value to a high value in a case where the brightness indicated by the brightness information is predicted to be lower than predetermined brightness.

7. The light control system according to claim 1,
wherein the control unit changes the target value to a low value in a case where the brightness indicated by the brightness information is predicted to be higher than predetermined brightness.

8. The light control system according to claim 1,
wherein the control unit
changes the target value to 500 lx or more as a low value of the target value, and
changes the target value to 1,000 lx or less as a high value of the target value.

9. The light control system according to claim 1,
wherein the acquisition unit is a sensor that measures brightness of outdoor light.

10. The light control system according to claim 1,
wherein the acquisition unit is a sensor installed on a window surface or a solar irradiance meter installed on a roof.

11. The light control system according to claim 1,
wherein the acquisition unit includes a first acquisition unit which is a sensor installed on a window surface or a solar irradiance meter installed on a roof and a second acquisition unit which is a sensor that measures brightness of a desk top surface, a floor surface, or a wall surface, and
the control unit changes the target value relating to second brightness information acquired by the second acquisition unit, based on first brightness information acquired by the first acquisition unit.

12. The light control system according to claim 1,
wherein the acquisition unit is a sensor that measures brightness of a desk top surface, a floor surface, or a wall surface, and
the control unit changes the target value based on brightness information representing the brightness of the desk top surface, the floor surface, or the wall surface.

13. The light control system according to claim 1,
wherein the acquisition unit acquires information representing a sky image or a cloud amount, and
the control unit changes the target value according to whether or not the sun is hidden by a cloud.

14. The light control system according to claim 1,
wherein the lighting unit is any one of lighting that illuminates a visual work surface or lighting that illuminates surroundings.

15. The light control system according to claim 14,
wherein the lighting unit is the lighting that illuminates surroundings,
the target value is changed to 100 lx or more as a low value of the target value, and
the target value is changed to 500 lx or less as a high value of the target value.

16. A light control device comprising:
a daylighting unit that takes in outside light;
a lighting unit that is able to adjust an output of light;
an acquisition unit that acquires brightness information representing brightness, including at least brightness of the outside light taken in from the daylighting unit;
a control unit that controls a light output of the lighting unit toward a target value; and
an acquisition unit that acquires brightness information representing brightness,
wherein the control unit changes the target value based on the brightness information.
